(19) United States
(12) Patent Application Publication
(10) Pub. No.: US 2026/0030055 A1
(43) Pub. Date: Jan. 29, 2026

(54) DISTRIBUTED COMPUTING METHOD, APPARATUS, DEVICE AND SYSTEM AND READABLE STORAGE MEDIUM

(71) Applicant: IEIT SYSTEMS (Beijing) Co., Ltd., Beijing (CN)

(72) Inventors: Dongdong SU, Beijing (CN); Yanmei SHEN, Beijing (CN); Wei LIU, Beijing (CN); Yanwei WANG, Beijing (CN)

(73) Assignee: IEIT SYSTEMS (Beijing) Co., Ltd., Beijing (CN)

(21) Appl. No.: 19/138,549

(22) PCT Filed: Sep. 10, 2024
(86) PCT No.: PCT/CN2024/118056

§ 371 Date: Jun. 12, 2025

(30) Foreign Application Priority Data
Oct. 17, 2023 (CN) 202311338201.8

(51) Int. Cl. G06F 9/48; G06F 9/50; G06F 13/40

(52) U.S. Cl. CPC G06F 9/4881; G06F 9/5077; G06F 13/4063; G06F 2209/505; G06F 2213/0026

(57) ABSTRACT

The present application discloses a distributed computing method, apparatus, device and system and a readable storage medium. The distributed computing method is applied to a controller of a distributed accelerator cluster and includes: acquiring information of accelerators in the distributed accelerator cluster; establishing an accelerator direct-connection pair according to the information of the accelerators; and in response to receiving a service task, dividing the service task into computing tasks and distributing the computing tasks to an idle target accelerator having an application computing logic matching the type of the corresponding computing tasks, wherein the accelerator direct-connection pair includes two accelerators that are directly connected to each other, and at least one of the two accelerators is a first accelerator that supports a computer express link protocol and has an extended memory, and/or the two accelerators have the same application computing logic.

### CROSS-REFERENCE TO RELATED APPLICATION

This application is a national stage entry of International Patent Application No. PCT/CN2024/118056, filed on Sep. 10, 2024, which claims priority to the Chinese Patent Application No. 202311338201.8, filed on Oct. 17, 2023 to China National Intellectual Property Administration and entitled “Distributed Computing Method, Apparatus, Device and System and Readable Storage Medium”. International Patent Application No. PCT/CN2024/118056 and Chinese Patent Application No. 202311338201.8 are each incorporated herein by reference in their entireties.

### FIELD

The present application relates to a distributed computing method, apparatus, device and system and a readable storage medium.

### BACKGROUND

With the development of artificial intelligence, the number of intensive computing scenarios is increasing, and a plurality of accelerators are often required to work together, such as in video editing, data encryption and decryption, and other cases. With the advent of accelerator virtualization technologies and accelerator pooling technologies, hardware of the plurality of accelerators is virtualized and pooled by establishing a distributed accelerator cluster, and the ability to process a large scale of computing tasks might be obtained through parallel computing. However, the parallel computing efficiency of the distributed accelerator cluster is seriously affected by the fact that the distributed accelerator cluster requires a controller-side server to assign and schedule computing tasks, complete input/output interactions of data, and perform context configuration, etc.

How to improve the parallel processing efficiency of accelerators in the existing distributed accelerator cluster is a technical problem that need to be solved by a person skilled in the art.

### SUMMARY

According to an embodiment disclosed by the present application, a distributed computing method is provided. The distributed computing method is applied to a controller of a distributed accelerator cluster and includes:
acquiring information of accelerators in the distributed accelerator cluster;
establishing an accelerator direct-connection pair according to the information of the accelerators; and
in response to receiving a service task, dividing the service task into computing tasks and distributing the computing tasks to an idle target accelerator having an application computing logic matching the type of the corresponding computing tasks, whereby the target accelerator executes the computing tasks and shunt the computing tasks to a direct-connected accelerator or to an indirect-connected accelerator via the controller when the target accelerator is in a computing overload state,
wherein the accelerator direct-connection pair includes two accelerators that are directly connected to each other, and at least one of the two accelerators is a first accelerator that supports a computer express link protocol and has an extended memory, and/or the two accelerators have the same application computing logic.

According to an embodiment disclosed by the present application, a distributed computing method is further provided. The distributed computing method is applied to a target accelerator in a distributed accelerator cluster and includes:
receiving and executing computing tasks divided and assigned by a controller of the distributed cluster according to a service task;
shunting the computing tasks to a direct-connected accelerator or to an indirect-connected accelerator via the controller when the target accelerator is in a computing overload state; and
wherein the target accelerator is an accelerator that are in an idle state and has an application computing logic matching the type of the corresponding computing tasks; the distributed accelerator cluster includes a pre-established accelerator direct-connection pair, wherein the accelerator direct-connection pair includes two accelerators that are directly connected to each other, and at least one of the two accelerators is a first accelerator that supports a computer express link protocol and has an extended memory, and/or the two accelerators have the same application computing logic.

According to an embodiment disclosed by the present application, a distributed computing method is further provided. The distributed computing method includes:
a controller of a distributed accelerator cluster acquiring information of accelerators in the distributed accelerator cluster and establishing an accelerator direct-connection pair according to the information of the accelerators;
the controller dividing a service task into computing tasks and distributing the computing tasks to a target accelerator in response to receiving the service task; and
the target accelerator performing the computing tasks and shunting the computing tasks to a direct-connected accelerator or to an indirect-connected accelerator via the controller when the target accelerator is in an overload state,
wherein the target accelerator is an accelerator that is in an idle state and has an application computing logic matching the type of the corresponding computing tasks; the accelerator direct-connection pair includes two accelerators that are directly connected to each other, and at least one of the two accelerators is a first accelerator that supports a computer express link protocol and has an extended memory, and/or the two accelerators have the same application computing logic.

According to an embodiment disclosed by the present application, a distributed computing apparatus is further provided. The distributed computing apparatus is applied to a controller of a distributed accelerator cluster and includes:
an acquisition unit, configured to acquire information of accelerators in the distributed accelerator cluster;
an establishment unit, configured to establish an accelerator direct-connection pair according to the information of the accelerators; and
an assignment unit, configured to, in response to receiving a service task, divide the service task into computing tasks and distribute the computing tasks to an idle target accelerator having an application computing logic matching the type of the corresponding computing tasks, whereby the target accelerator executes the computing tasks and shunts the computing tasks to a direct-connected accelerator or to an indirect-connected accelerator via a controller when the target accelerator is in a computing overload state,
wherein the accelerator direct-connection pair includes two accelerators that are directly connected to each other, and at least one of the two accelerators is a first accelerator that supports a computer express link protocol and has an extended memory, and/or the two accelerators have the same application computing logic.

According to an embodiment disclosed by the present application, a distributed computing apparatus is further provided. The distributed computing apparatus is applied to accelerators in a distributed accelerator cluster and includes:
an execution unit, configured to receive and execute computing tasks divided and assigned by a controller of the distributed cluster according to a service task; and
a shunting unit, configured to shunt the computing tasks to a direct-connected accelerator or to an indirect-connected accelerator via the controller while being in a computing overload state,
wherein the target accelerator is an accelerator that is in an idle state and has an application computing logic matching the type of the corresponding computing tasks; the distributed accelerator cluster includes a pre-established accelerator direct-connection pair, wherein the accelerator direct-connection pair includes two accelerators that are directly connected to each other, and at least one of the two accelerators is a first accelerator that supports a computer express link protocol and has an extended memory, and/or the two accelerators have the same application computing logic.

According to an embodiment disclosed by the present application, a distributed computing system is further provided. The distributed computing system includes a distributed accelerator cluster and a controller,
wherein the controller is configured to acquire information of accelerators in the distributed accelerator cluster; establish an accelerator direct-connection pair according to the information of the accelerators; and in response to receiving a service task, divide the service task into computing tasks and distribute the computing tasks to an idle target accelerator having an application computing logic matching the type of the corresponding computing tasks, whereby the target accelerator executes the computing tasks and shunts the computing tasks to a direct-connected accelerator or to an indirect-connected accelerator via the controller when the target accelerator is in a computing overload state; and
wherein the accelerator direct-connection pair includes two accelerators that are directly connected to each other, and at least one of the two accelerators is a first accelerator that supports a computer express link protocol and has an extended memory, and/or the two accelerators have the same application computing logic.

According to an embodiment disclosed by the present application, a distributed computing device is further provided. The distributed computing device includes:
a storage device, configured to store computer-readable instructions therein; and
a processor, configured to execute the computer-readable instructions, the computer-readable instructions, when being executed by the processor, implementing the steps in any of the above distributed computing methods.

According to an embodiment disclosed by the present application, a non-volatile computer-readable storage medium is further provided, having computer-readable instructions stored therein, wherein the computer-readable instructions, when being executed by a processor, implement the steps in any of the above distributed computing methods.

Details of one or more embodiments of the present application are provided in the accompanying drawings and descriptions below. Other features and advantages of the present application become apparent from the Description, the drawings, and the claims.

### BRIEF DESCRIPTION OF THE DRAWINGS

To describe the embodiments of the present application or the technical solutions in the prior art more clearly, the following briefly introduces the accompanying drawings required for describing the embodiments or the descriptions in the prior art. Apparently, the accompanying drawings in the following description show merely some embodiments of the present disclosure, and a person of ordinary skill in the art may still derive other drawings from these accompanying drawings without creative efforts.

FIG. 1 is a schematic diagram of a virtualized structure of an accelerator that supports a computer express link protocol provided by an embodiment of the present application;

FIG. 2 is a schematic diagram of a virtualized structure of an accelerator that does not support a computer express link protocol provided by an embodiment of the present application;

FIG. 3 is a flowchart of a distributed computing method provided by an embodiment of the present application;

FIG. 4 is a structural diagram of the direct connection pair of accelerators;

FIG. 5 is a schematic structural diagram of a distributed computing apparatus provided by an embodiment of the present application;

FIG. 6 is a schematic structural diagram of a distributed computing device provided by an embodiment of the present application; and

FIG. 7 is a schematic structural diagram of a computer-readable storage medium provided by an embodiment of the present application.

### DETAILED DESCRIPTION

The core of the present application is to provide a distributed computing method, apparatus, device and system and a non-volatile readable storage medium, which are configured to improve the parallel processing efficiency of accelerators in the existing distributed accelerator cluster.

The technical solutions in the embodiments of the present application will be described clearly and completely below in conjunction with accompanying drawings in the embodiments of the present application. Of course, the described embodiments are merely some embodiments, rather than all embodiments, of the present application. Based on the embodiments in the present application, all other embodiments derived by a person of ordinary skill in the art without creative efforts shall fall within the protection scope of the present application.

An embodiment in a first aspect of the present application is described as follows.

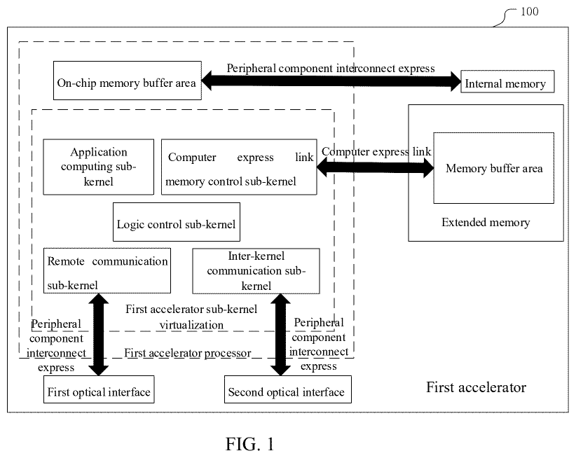

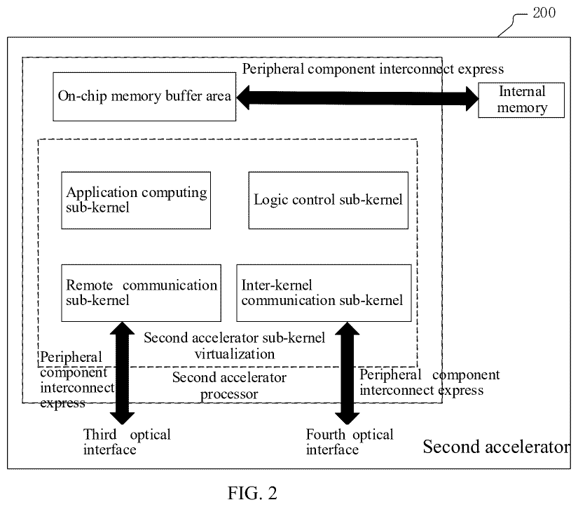

FIG. 1 is a schematic diagram of a virtualized structure of an accelerator that supports a computer express link protocol provided by an embodiment of the present application; and FIG. 2 is a schematic diagram of a virtualized structure of an accelerator that does not support a computer express link protocol provided by an embodiment of the present application.

For ease of understanding, a distributed computing system provided by an embodiment of the present application is described first.

In order to solve the problem of deep learning multi-layer neural network models in the field of artificial intelligence, more computing resources are needed to run ultra-large-scale neural network models. These ultra-large-scale neural networks often require the collaborative deployment of a plurality of heterogeneous accelerators, and when faced with massive amounts of computational data to be processed, two or even more heterogeneous accelerators need to be used for collaborative computation. There are many other compute-intensive scenarios, such as video editing, data encryption and decryption, and other scenarios, which often require a plurality of heterogeneous accelerators to work together. It is undeniable that with the improvement of the accelerator process, the computing time of a single heterogeneous accelerator is gradually shortened in the event of processing computing tasks having the same amount of data, while the storage and writing/reading of data in the heterogeneous accelerator and the data communication of a plurality of heterogeneous accelerators have become bottlenecks that limit the communication efficiency of the heterogeneous accelerators.

In order to save the time of the heterogeneous accelerator to process computing tasks, a traditional heterogeneous accelerator collaboration scheme uses a heterogeneous accelerator as a coprocessor of a central processing unit (CPU) of a server. A field programmable gate array (FPGA), a graphic processing unit (GPU) and other accelerators are mostly inserted onto a peripheral component interconnect express (PCIe) interface of the server, and a master-slave control mode is adopted, wherein the CPU is taken as a master end and the accelerator is taken as a slave device. In this process, the CPU needs to interact (e.g., data preprocessing, contextual interaction, and data reception) with the heterogeneous accelerator, and the corresponding data also needs to be transmitted to the heterogeneous accelerator through a PCIe channel. When a plurality of heterogeneous accelerators collaboratively process computing tasks, the CPU is also required to make interactions. Therefore, this results in additional CPU interaction time and PCIe transmission time.

In order to solve this problem, the relevant technical fields propose to integrate a smart network interface card function on the traditional FPGA accelerator, and realize the traditional heterogeneous computing function and communication function at the same time through the combination of “FPGA+ASIC”. In addition, there are also technologies that propose a distributed FPGA accelerator cluster network applicable to FPGA accelerators not assisted by FPGA such as non-ASIC. The remote direct memory access (RDMA) network communication capability is achieved on a FPGA accelerator with an optical communication capability, enabling network communication and application computing between the FPGA accelerator and a server. In addition, with the help of the FPGA's inter-kernel communication protocol, kernels of the FPGA accelerator kernels might realize high-speed interconnection of network data. The FPGA accelerator may expand the benefits of parallel computing on the basis of the network communication function.

However, the FPGA accelerators still have a number of problems. On the one hand, although FPGA accelerators on different platforms might communicate with the help of their programmability compared with GPU, they are still limited by the limited load capacity of a data memory inside such as an internal memory (e.g., double data rate SDRAM, DDR SDRAM). On the other hand, the amount of data processed by each FPGA accelerator for computing tasks is still limited by CPU regulation. In the case of processing massive computing tasks, the FPGA accelerator and the CPU need to interact frequently, and hence the CPU might know a running state and task assignment of the FPGA accelerator in time.

In order to optimize the performances of the FPGA accelerators, there are FPGA accelerators implemented in combination with a compute express link (CXL) technology. The CXL technology is a cache-coherent interconnect protocol for processors, memory expansion and accelerators, that allow resource sharing for higher performances, reduce the complexity of software stack, and lower the overall system cost by maintaining the consistency between a CPU memory space and a memory on an attached device. This enables the users to simply focus on a target workload rather than redundant memory management hardware in the accelerators. In a CXL specification, three types of devices are defined for the CXL protocol: (1) a device that wants to cache data in a CPU main memory locally, in which case, the device only needs to use a compute express link input/output (CXL.I/O) protocol and a compute express link cache (CXL.cache) protocol; (2) a device that has a memory on an accelerator and wants interactions between a CPU and the accelerator, in which case, the computer express link input/output (CXL.I/O) protocol is used to allow the CPU to discover and configure the device, and then the computer express link cache (CXL.cache) protocol is used to allow the device to access the memory of the CPU and a compute express link memory protocol (CXL.mem) is used to allow the CPU to access the memory of the device; and (3) a memory buffer area, in which case, the computer express link input/output (CXL.I/O) protocol is required to discover and configure a device, and the computer express link memory (CXL.mem) protocol is used to enable a processor such as CPU to access a memory connected to the memory buffer area. As described in (1) and (3), based on the computer express link protocol, a new FPGA accelerator might store a device to be processed therein by increasing a physical memory, allowing the FPGA accelerator to access in time.

However, although this accelerator based on the computer express link protocol might directly read data from its own increased physical memory compared with ordinary accelerators, improving the average data access efficiency between the CPU and the accelerator, if this accelerator is still connected in the traditional accelerator mode in which the accelerator is inserted onto a specific PCIe interface of the server that supports the computer express link protocol, the CPU is still required to complete the assignment and scheduling of computing tasks, and complete the interactions and context configuration of input and output data, etc., so the use efficiency is still limited and the parallel computing capacity is not improved significantly compared with a distributed accelerator cluster composed of ordinary accelerators. In addition, because a new accelerator needs to support a specific computer express link protocol and an additional memory, the corresponding cost is greatly increased, so there is no scheme to apply accelerators based on the computer express link protocol to a distributed accelerator cluster.

In the case of computing overload, the distributed accelerator cluster is limited by a small memory space of an accelerator and needs to interact frequently with a controller-side server, resulting in high latency and slow parallel processing rate. However, an accelerator based on the computer express link protocol and having an extended memory still exists as a co-processor of the traditional server CPU, and still needs to interact frequently with the CPU, resulting in low data processing rate, excessively high cost and no introduction of an accelerator virtualization technology into an accelerator cluster as a standalone computing engine, and other problems. An embodiment of the present application provides a distributed computing system. The distributed computing system includes a distributed accelerator cluster and a controller,
wherein the controller is configured to acquire information of accelerators in the distributed accelerator cluster; establish an accelerator direct-connection pair according to the information of the accelerators; and in response to receiving a service task, divide the service task into computing tasks and distribute the computing tasks to an idle target accelerator having an application computing logic matching the type of the corresponding computing tasks, whereby the target accelerator executes the computing task and shunt the computing tasks to a direct-connected accelerator or to an indirect-connected accelerator via the controller when the target accelerator is in a computing overload state,
wherein the accelerator direct-connection pair includes two accelerators that are directly connected to each other, and at least one of the two accelerators is a first accelerator that supports a computer express link protocol and has an extended memory, and/or the two accelerators have the same application computing logic.

In the distributed computing system provided in the embodiment of the present application, the distributed accelerator cluster is composed of a plurality of accelerators, and network connections between the accelerators and between the accelerators and a controller are implemented through a routing protocol. The accelerators in the distributed accelerator cluster may be the same type of computing devices or heterogeneous computing devices, including but not limited to: graphic processing units (GPUs), field programmable gate array (FPGA) devices, application-specific integrated circuits (ASICs), and data processing units (DPUs). In order to facilitate the establishment of a large-scale cluster, FPGA may be adopted as the accelerator in the embodiment of the present application, and programmable characteristics of the FPGA are used to realize the communication between the FPGAs of different platforms, making it easier for the cluster to expand. The distributed accelerator cluster provided by the embodiment of the present application includes at least one accelerator that supports a computer express link protocol and has an extended memory. The controller in the embodiment of the present application may include, but is not limited to, a control-side server of the distributed accelerator cluster or a CPU of the control-side server.

For ease of description, in the embodiment of the present application, a first accelerator is defined as an accelerator that supports the computer express link protocol and has an extended memory; a second accelerator is defined as an accelerator that does not support the computer express link protocol and does not have an extended memory; a target accelerator is defined as an idle accelerator that is selected by the controller at the time of assigning compute tasks and has an application computing logic matching the type of the corresponding computing tasks; a direct-connected accelerator is defined as an identity of one of the accelerators in any accelerator direct-connected pair relative to the other; an indirect-connected accelerator is defined as an accelerator that has no direct-connection relationship with the current accelerator and does not belong to the same accelerator direct-connection pair; and an accelerator to be shunted is defined as a destination accelerator for the target accelerator that is to shunt the computing tasks, which may be a direct-connected accelerator or an indirect-connected accelerator for the target accelerator.

As shown in FIG. 1 and FIG. 2, sub-kernels in the first accelerator and the second accelerator are respectively divided according to a logical function to be achieved in combination with a kernel virtualization technology.

As shown in FIG. 1, the kernel in the first accelerator 100 may be divided into five parts: an application computing sub-kernel, a remote communication sub-kernel, an inter-kernel communication sub-kernel, a logic control sub-kernel, and a computer express link memory control sub-kernel.

The application computing sub-kernel is configured to execute computing tasks assigned by a controller, such as deep neural network computing. An application computing logic in the application computing sub-kernel carried for the accelerator is pre-deployed or burnt in the accelerator, for executing computing tasks. That is, the controller needs to assign the computing tasks to the accelerators that have matching application computing logics at the time of assigning the computing tasks.

The remote communication sub-kernel is responsible for data interactions with the controller or other accelerators on the basis of a routing protocol. In order to improve the data interaction efficiency, the communication sub-kernel may adopt a remote direct memory access (RDMA) protocol, which requires all of the first accelerator 100, a router and accelerators interacting with the first accelerator 100 to support the RDMA protocol. As shown in FIG. 1, if the first accelerator 100 is FPGA, the communication sub-kernel may complete data interactions based on the RDMA protocol by using a first optical interface of FPGA.

The inter-kernel communication sub-kernel is configured to realize peer-to-peer data communication between direct-connected accelerators. As shown in FIG. 1, if the first accelerator 100 is FPGA, the inter-kernel communication sub-kernel may perform peer-to-peer data communication between the direct-connected accelerators by using a second optical interface of FPGA.

The logic control sub-kernel is configured to implement basic logic configuration, task distribution management, monitoring management, and memory management of the first accelerator 100. The memory management includes not only the management and assignment of an on-chip memory buffer area of the first accelerator 100 and a local memory space of the first accelerator 100 such as an internal memory (e.g., DDR SDRAM), but also includes the management of a memory buffer area of an extended memory based on the computer express link protocol. If other accelerators apply to use the expanded memory of the first accelerator 100, the first accelerator 100 is based on memory assignment and management when the logic control sub-kernel is configured to apply an extended memory for other accelerators.

The computer express link memory control sub-kernel is configured to realize the use of the first accelerator 100 to the extended memory by completing the computer express link input/output (CXL.I/O) protocol, the computer express link memory protocol (CXL.mem) and other protocols that support the computer express link protocol of the first accelerator 100 of the extended memory.

As shown in FIG. 2, the kernel in the second accelerator 200 may be divided into four parts: an application computing sub-kernel, a remote communication sub-kernel, an inter-kernel communication sub-kernel, and a logic control sub-kernel.

The application computing sub-kernel is configured to execute computing tasks assigned by a controller, such as deep neural network computing. An application computing logic in the application computing sub-kernel carried for the accelerator is pre-deployed or burnt in the accelerator, for executing computing tasks. That is, the controller needs to assign the computing tasks to the accelerators that have matching application computing logics at the time of assigning the computing tasks.

The remote communication sub-kernel is responsible for data interactions with the controller or other accelerators on the basis of a routing protocol. In order to improve the data interaction efficiency, the communication sub-kernel may adopt a RDMA protocol, which requires all of the second accelerator 200, a router and accelerators interacting with the second accelerator 200 to support the RDMA protocol. As shown in FIG. 2, if the second accelerator 200 is FPGA, the communication sub-kernel may complete data interactions based on the RDMA protocol by using a second optical interface of FPGA.

The inter-kernel communication sub-kernel is configured to implement peer-to-peer data communication between direct-connected accelerators. As shown in FIG. 2, if the second accelerator 200 is FPGA, the inter-kernel communication sub-kernel may implement peer-to-peer data communication between the direct-connected accelerators by using a fourth optical interface of FPGA.

The logic control sub-kernel is configured to implement basic logic configuration, task distribution management, monitoring management, and memory management of the second accelerator 200. The memory management includes not only the management and assignment of an on-chip memory buffer area of the second accelerator 200 and a local memory space of the second accelerator 200 such as an internal memory (e.g., DDR SDRAM), but also includes shunting of the computing tasks together with the assigned first accelerator on the basis of the compute shunting method provided by the embodiment of the present application in the case that the memory space of the second accelerator 200 is insufficient.

Based on the routing protocol (e.g., RDMA protocol), the first and second accelerators are connected to a routing subnetwork of the distributed accelerator cluster. Based on the inter-kernel communication (IKC) protocol, a pairwise direct-connection relationship between the accelerators is established in the distributed accelerator cluster. Further, in addition to the traditional routing link, an inter-kernel high-speed transmission link may be used to implement fast shunting between the direct-connected accelerators. If the direct-connected accelerator is the first accelerator, it mingt also implement shared occupation of the extended memory based on the inter-kernel high-speed transmission link. However, for the indirect-connected accelerator, it might also implement occupation of the extended memory of the idle first accelerator through the routing subnetwork. Compared with the traditional scheme of dividing a storage pool as a shared memory, the access rate is greatly increased because the accelerators are all located in the same routing subnetwork even if the indirect-connected accelerator occupies the extended memory. Therefore, according to the distributed computing system provided by the embodiment of the present application, in addition to the traditional routing link, the accelerators in the distributed accelerator cluster might also implement peer-to-peer express link with the direct-connected accelerator through the inter-kernel high-speed transmission link, and might occupy the extended memory of the first accelerator in the cluster, so the first accelerator that supports the computer express link protocol might give full play to the performance advantages in the distributed accelerator cluster. However, for the entire distributed accelerator cluster, it is equivalent that each accelerator has an elastic memory, and in the case of sufficient memory, has the opportunity to apply for the extended memory of the first accelerator to improve its own read/write efficiency and reduce the interactions with the controller, thereby improving the efficiency of parallel computing.

As shown in FIG. 1, the memory of the first accelerator includes an internal memory (e.g., DDR SDRAM), an on-chip memory buffer area and a memory buffer area formed by the extended memory. As shown in FIG. 2, the memory of the second accelerator includes an internal memory (e.g., DDR SDRAM), and an on-chip memory buffer area. In order to give full play to the advantages of interconnected acceleration and memory expansion of the distributed accelerator cluster, any type of accelerator deployed in the same routing subnetwork in the distributed accelerator cluster might be set, and the application computing logics in the application computing sub-kernel in the distributed accelerator cluster are as close to the same as possible to facilitate collaborated and unified management of data assignment. Alternatively, to address a plurality of scenarios, the distributed accelerator cluster may include accelerators with several different application computing logics. The extended memory of the first accelerator and the inter-kernel high-speed transmission link between the direct-connected accelerators are sufficiently utilized, whereby data offloading or memory sharing of computing tasks might be implemented between the two accelerators.

In order to reduce the complexity of data shunting for the computing tasks in different routing subnetworks and adapt to latency-sensitive computing, all accelerators in the distributed accelerator cluster may be connected to the same routing subnetwork to avoid the problem of excessive delay caused by network congestion during cross-network forwarding. However, to improve the performance of direct-connection deployment in the distributed accelerator cluster, two first accelerators or two accelerators having the same application computing logic may be preferentially adopted to establish an accelerator direct-connection pair. Since the direct connection between two second accelerators having different application computing logics cannot significantly improve the compute shunting efficiency, the accelerator direct-connection pair needs to satisfy at least one of conditions that at least one of the two accelerators is a first accelerator that supports the computer express link protocol and has an extended memory, and the two accelerators have the same application computing logic.

The distributed computing method provided by the embodiment of the present application will be introduced below on the basis of the above architecture in conjunction with accompanying drawings.

An embodiment in a second aspect of the present application is described as follows.

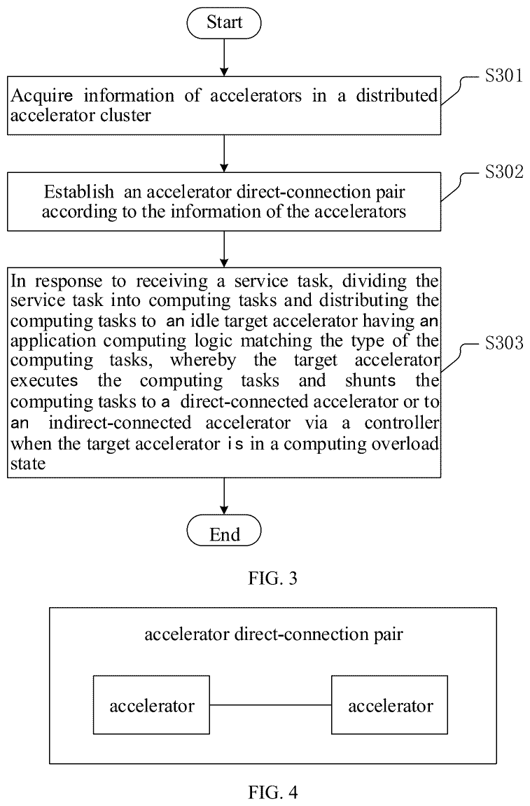

FIG. 3 is a flowchart of a distributed computing method provided by an embodiment of the present application.

As shown in FIG. 3, a controller applied to a distributed accelerator cluster is shown. The distributed computing method provided by the embodiment of the present application includes:
S301: acquiring information of accelerators in the distributed accelerator cluster;
S302: establishing an accelerator direct-connection pair according to the information of the accelerators; and
S303: in response to receiving a service task, dividing the service task into computing tasks and distributing the computing tasks to an idle target accelerator having an application computing logic matching the type of the corresponding computing tasks, whereby the target accelerator executes the computing tasks and shunts the computing tasks to a direct-connected accelerator or to an indirect-connected accelerator via the controller when the target accelerator is in a computing overload state,
wherein as shown in FIG. 4, the accelerator direct-connection pair includes two accelerators that are directly connected to each other, and at least one of the two accelerators is a first accelerator that supports a computer express link protocol and has an extended memory, and/or the two accelerators have the same application computing logic.

In conjunction with the distributed computing system provided by the embodiment in the first aspect of the present application, an embodiment of the present application provides a distributed computing method. For S301, prior to scheduling the computing tasks, the controller establishes a state management mechanism with the corresponding accelerators in the distributed accelerator cluster under its management. The controller establishes a storage mechanism in the form of a table to manage a usage state of each accelerator, which may be denoted as an accelerator state information table, by acquiring information (e.g., unique identifiers of the accelerators, network addresses of the accelerators, the types of the accelerators, and performance parameters of the accelerators) of the accelerators in the distributed accelerator cluster.

The accelerator state information table may be a hash table, in which keys are network addresses of the corresponding accelerators and the corresponding values are state information of the accelerators. A field with a length of 134 bits may be used as the accelerator state information table. The field and its meaning are shown in Table 1.

TABLE 1
Accelerator state information table

| Bit Nos. | State meanings |
|---|---|
| 0# | Usage state information of accelerators, where 1 indicates that the accelerator is |
| | not idle and 0 represents that the accelerator is idle. The default value is 0. |
| 1# | Whether the accelerator supports the computer express link protocol, 1 indicates |
| | that the accelerator supports the computer express link protocol, and 0 indicates |
| | that the accelerator does not support the computer express link protocol. The |
| | default value is 0. |
| 2# | Whether the accelerator is directly connected to other accelerators, 1 indicates |
| | that there is a direct-connected accelerator, and 0 indicates that there is no direct- |
| | connected accelerator. The default value is 0. |
| 3# | Whether the accelerator has an extended memory that has been shared with other |
| | accelerators, 1 indicates that the extended memory has been shared, and 0 |
| | indicates that the extended memory has not been shared. The default value is 0. |
| 4#-7# | The type of an application computing logic in the application computing sub- |
| | kernel of the accelerator, having a value ranging from 0 to 15, wherein the |
| | corresponding application logic type and corresponding value thereof are set |
| | according to actual service scenarios. The default value is 0. |
| 8#-39# | The network address of an accelerator directly connected to another accelerator. |
| | The default value is 00000000000000000000000000000000. |
| 40#-82# | The start time in current use of the accelerator, wherein all bits are 0 by default |
| | if the current accelerator is idle. The default value is |
| | 0000000000000000000000000000000000000000000. Unit: millisecond. |
| 83#-125# | The end time in latest use of the accelerator, wherein all bits are 0 by default if |
| | the accelerator is not used or in a non-idle state currently. |
| | The default value is 0000000000000000000000000000000000000000000. |
| | Unit: millisecond. |
| 126#-133# | Nos. of routing subnetworks to which the accelerators belong. The value ranges |
| | from 0 to 255. The default value is 0. |

As described in Table 1, after the distributed accelerator cluster is initialized, the controller may collect real-time state information of the accelerators to maintain the accelerator state information table corresponding to the accelerators, and edit the corresponding values in Table 1 based on whether the accelerators support the computer express link protocol, whether the direct-connected accelerator is established, the network address of the direct-connected accelerator, Nos. of routing subnetworks, etc.

For S302, according to the types of the accelerators, the controller establishes an accelerator direct-connection pair for one group of two accelerators, and ensures that the accelerator direct-connection pair satisfies at least one of the conditions: at least one of the two accelerators is a first accelerator that supports the computer express link protocol and has an extended memory and the two accelerators have the same application computing logic. As described in the embodiment of the first aspect of the present application, an inter-kernel communication (IKC) protocol may be used to establish a direct-connection relationship between two accelerators to form the accelerator direct-connection pair. Then, S302, i.e., establishing the accelerator direct-connection pair according to the information of the accelerators may include: establishing the accelerator direct-connection pair by applying the inter-kernel communication protocol. Meanwhile, the target accelerator shunting the computing tasks to the direct-connected accelerator in S303 may include: the target accelerator shunting the computing tasks to the direct-connected accelerator for the target accelerator based on the inter-kernel high-speed transmission link.

In response to the accelerator direct-connection pair being established, a five-level priority direct-connection method provided in the embodiment of the present application may be further selected to establish the accelerator direct-connection pair. That is, establishing the accelerator direct-connection pair according to the information of the accelerators in S302 may include:
dividing the accelerators in the distributed accelerator cluster and establishing the accelerator direct-connection pair, by taking the accelerator direct-connection pair assembled by two first accelerators having the same application computing logic as a first priority, the accelerator direct-connection pair assembled by one first accelerator and one second accelerator that does not support the computer express link protocol and has the same application computing logic as that of the first accelerator as a second priority, the accelerator direct-connection pair assembled by two second accelerators having the same application computing logic as a third priority, the accelerator direct-connection pair assembled by two first accelerators having different application computing logics as a fourth priority, and the accelerator direct-connection pair assembled by on first accelerator and one second accelerator having different application computing logics as a fifth priority.

According to an order of the first priority, the second priority, the third priority, the fourth priority, and the fifth priority, when two accelerators in the distributed accelerator cluster satisfy corresponding priority conditions, the higher the corresponding priority is, the higher the probability of being assigned to the same accelerator direct-connection pair is. That is, at the time of grouping, it is considered to establish more accelerator direct-connection pairs of the first priority, followed by the second priority, and so on.

For S303, in response to receiving a service task, the controller splits the service task into computing tasks based on the type of the accelerator under management, and distributes the computing tasks to an idle target accelerator having an application computing logic matching the type of the corresponding compute tasks. In addition to the distribution of the computing tasks, for various scenarios such as any type of accelerator in the distributed accelerator cluster starting to execute computing tasks and end the computing tasks, the extended memory being occupied, and compute shunting being required during the computing process, the controller monitors the real-time state information of the accelerators and assists in a compute shunting requirement for the target accelerator.

Since there is at least one accelerator direct-connection pair in the distributed accelerator cluster, and the two accelerators in the accelerator direct-connection pair may perform peer-to-peer express link based on the kernel communication protocol, the computing tasks may be preferentially distributed to the accelerators in the accelerator direct-connection pair. Meanwhile, if the accelerator is the first accelerator but its extended memory is occupied, the read/write performance will be degraded, so the computing tasks are preferentially distributed to the first accelerator whose extended memory is not occupied. The controller dividing the service task into the computing tasks and distributing the computing tasks to the target accelerator that has an application computing logic matching the type of the corresponding computing tasks and is not occupied in S303 may include: selecting the target accelerator according to at least one of a direct-connection relationship and extended memory occupation, dividing the service task into computing tasks and distributing the computing tasks to the target accelerator.

Due to the differences in models and production processes of different accelerators, the execution time of parallel computing is different, and the computing tasks assigned by the controller may cause some target accelerators to be in a computing overload state and delay in completing the computing tasks. Therefore, it is necessary to perform a shunting operation of the computing tasks on the target accelerator when the target accelerator is in the computing overload state.

The way to determine that the target accelerator is in the computing overload state may be that the target accelerator takes much longer to execute the same type of computing tasks than other accelerators. For example, if the average execution time for the same type of computing tasks on a single accelerator is first time, and the execution time of the target accelerator exceeds the first time, the target accelerator may be determined to be in the computing overload state. The way to determine that the target accelerator is in the computing overload state may also be that the memory of the target accelerator is fully occupied for a long time. Then, the target accelerator being in the computing overload state in S302 may include: the target accelerator recording a full occupation timestamp (denoted as T_{fstocpy}) when the local memory is fully occupied for the first time, and querying an occupation state of a local memory every query cycle (e.g., Δt); and determining the local memory to be in the computing overload state in the case that the local memory is still fully occupied for a continuous preset cycle. The local memory may be an internal memory (e.g., DDR SDRAM), or all local memories including the internal memory, the on-chip memory buffer area and the extended memory.

At the time of determining that the local memory is in the computing overload state, the target accelerator begins to seek other accelerators to shunt local computing tasks. If there is a direct-connected accelerator for the target accelerator, the direct-connected accelerator has the same application computing logic as that of the target accelerator, and the direct-connected accelerator is in an idle state, the target accelerator may shunt the computing tasks to the direct-connected accelerator through the inter-kernel high-speed transmission link. If this condition is not satisfied, the target accelerator needs to select an indirect-connected accelerator to shunt the computing tasks. The target accelerator performing the computing tasks and shunting the computing tasks to the direct-connected accelerator or to the indirect-connected accelerator via the controller when the target accelerator is in a computing overload state in S303 may include:
the target accelerator shunting the computing tasks to the direct-connected accelerator for the target accelerator in the case that the target accelerator is in the computing overload state and the direct-connected accelerator for the target accelerator satisfies a condition that it is in an idle state and has the same application computing logic as that of the target accelerator; and
assigning the indirect-connected accelerator to the target accelerator as an accelerator to be shunted, whereby the target accelerator shunts the computing tasks to the accelerator to be shunted, in the case that the target accelerator is in the computing overload state and no direct-connected accelerator is provided for the target accelerator or the direct-connected accelerator for the target accelerator is in a non-idle state or the direct-connected accelerator for the target accelerator has different application computing logic from that of the target accelerator.

It may be understood that since the target accelerator and the direct-connected accelerator might communicate based on the inter-kernel high-speed transmission link, the target accelerator preferably shunts the computing tasks to the direct-connected accelerator compared with the indirect-connected accelerator. In order to facilitate the target accelerator to quickly know whether it has a condition to shunt the computing tasks to the direct-connected accelerator, the state information of the direct-connected accelerator may be maintained at both accelerators in each accelerator direct-connection pair. A direct-connected accelerator information table may be established to record whether the direct-connected accelerator is in an idle state, whether the direct-connected accelerator supports the computer express link protocol, whether the direct-connected accelerator has an extended memory, whether the extended memory is occupied, and other information. Then, in the distributed computing method provided by the embodiment of the present application, the two accelerators in the accelerator direct-connection pair may share local application computing logic types, usage state information, whether to support the computer express link protocol and whether to occupy the extended memory through a direct-connected channel, and record the information of the direct-connected accelerator to the direct-connected accelerator state information table.

However, when the computing tasks need to be shunted to the indirect-connected accelerator, in order to enable the target accelerator to quickly know what resources might be obtained from the accelerator to be shunted, and to maintain the state information of the accelerator to be shunted at each accelerator, an information table of the accelerator to be shunted may be established to record whether the accelerator to be shunted is in an idle state, whether the accelerator to be shunted supports the computer express link protocol, whether the accelerator to be shunted has an extended memory, whether the extended memory is occupied, and other information. Then, in the distributed computing method provided by the embodiment of the present application, the target accelerator shunts the computing tasks to the indirect-connected accelerator via the controller, receives the information of the accelerator to be shunted sent by the controller, and records the information into a state information table of the accelerator to be shunted.

The accelerators may maintain a compute shunting accelerator state information table. Details may be shown in Table 2. The compute shunting accelerator state table corresponds to a numerical field having a length of 75 bits, and the meaning of the field is shown in Table 2.

TABLE 2
Compute shunting accelerator state information table

| Bit Nos. | State meanings |
|---|---|
| 0# | Usage state information of the direct-connected accelerator, where 1 |
| | indicates that the direct-connected accelerator is in a non-idle state and 0 |
| | represents that the direct-connected accelerator is in an idle state. The |
| | default value is 0. |
| 1# | Whether the direct-connected accelerator supports the computer express |
| | link protocol, where 1 indicates that the direct-connected accelerator |
| | supports the computer express link protocol, and 0 indicates that the |
| | direct-connected accelerator does not support the computer express link |
| | protocol. The default value is 0. |
| 2# | Whether the accelerator to be shunted supports the computer express link |
| | protocol, where 1 indicates that the accelerator to be shunted supports the |
| | computer express link protocol, and 0 indicates that the accelerator to be |
| | shunted does not support the computer express link protocol. The default |
| | value is 0. |
| 3# | Whether the accelerator to be shunted is directly connected to the current |
| | accelerator, where 1 indicates that the accelerator to be shunted is directly |
| | connected to the current accelerator, and 0 indicates that the accelerator to |
| | be shunted is not directly connected to the current accelerator. The default |
| | value is 0. |
| 4# | Whether the extended memory of the direct-connected accelerator is |
| | occupied, where 1 indicates that the extended memory has been occupied, |
| | and 0 indicates that the extended memory has not been occupied. The |
| | default value is 0. |
| 5# | Whether the extended memory of the accelerator to be shunted is |
| | occupied, where 1 indicates that the extended memory has been occupied, |
| | and 0 indicates that the extended memory has not been occupied. The |
| | default value is 0. |
| 6#-9# | The type of an application logic in the application computing sub-kernel |
| | of the accelerator to be shunted, having a valve ranging from 0 to 15. The |
| | default value is 0. |
| 10#-41# | The network address of the accelerator to be shunted. The default value is 0. |
| 42#-73# | The network address of the direct-connected accelerator. The default value is 0. |
| 74# | Whether there is a direct-connected accelerator for the accelerator to be |
| | shunted, where 1 indicates the presence of the direct-connected |
| | accelerator, and 0 indicates the absence of the direct-connected |
| | accelerator. The default value is 0. |

As mentioned above, the target accelerator shunts the computing tasks to the direct-connected accelerator on the basis of the inter-kernel high-speed transmission link. In the absence of the direct-connected accelerator or in the case that the direct-connected accelerator does not satisfy a shunting condition, the target accelerator needs to seek for an indirect-connected accelerator to shunt the computing tasks. To ensure the efficiency of shunting to the indirect-connected accelerator, the controller selects the indirect-connected accelerator for the target accelerator as the accelerator to be shunted for the target accelerator. Then, the target accelerator shunting the computing tasks to the indirect-connected accelerator via the controller in S303 may include:
receiving a shunting request sent by the target accelerator;
determining the accelerator to be shunted on the basis of the shunting request; and
sending the information of the accelerator to be shunted to the target accelerator, whereby the target accelerator shunts the computing tasks to the accelerator to be shunted via a routing subnetwork.

The target accelerator sends a shunting request to the controller, which queries the accelerator state information table of the accelerators in the distributed accelerator cluster, selects one or more accelerators to be shunted, and feeds the information (ID or network address) of the accelerator to be shunted back to the target accelerator, enabling the target accelerator to interact with the accelerator to be shunted for the shunting of the computing tasks.

In order to improve the efficiency of data interactions between the controller and the accelerator and between the two accelerators, the traditional transmission control protocol (TCP)/user datagram protocol (UDP) may be replaced by the RDMA protocol. Then, the target accelerator shunting the computing tasks to the accelerator to be shunted via the routing subnetwork may include: the target accelerator shunting the computing tasks to the accelerator to be shunted via the routing subnetwork on the basis of the RDMA protocol.

In order to ensure that the assigned accelerator to be shunted might quickly complete the computing tasks shunted by the target accelerator, the accelerator to be shunted with better performance should be selected. Then, determining the accelerator to be shunted on the basis of the shunting request may include: acquiring an accelerator list of the distributed accelerator cluster; determining in the accelerator list information indicating that the accelerators that have the same application computing logic as that of the target accelerator and are idle are candidate shunting accelerators; and selecting the candidate shunting accelerator that satisfies the longest idle time and/or belongs to the first accelerators as the accelerator to be shunted. The controller may know the accelerator that has the longest idle time among the idle accelerators having the same application computing logic as that of the target accelerator by querying the accelerator state information table of the accelerators in the distributed accelerator cluster, and preferably select the first accelerator with better read/write performance as the accelerator to be shunted. The accelerator state information table is shown in Table 1. Then, the controller reads bits 83-125 to obtain the end time of the last computing task on this idle accelerator, and finds the accelerator/first accelerator with the earliest end time as the accelerator to be shunted.

In the embodiment of the present application, the accelerator is in the idle state, which may mean only that the application computing sub-kernel of the accelerator is in an idle state, or that both the application computing sub-kernel of the accelerator and the extended memory of the accelerator are in an idle state, or at least one of them is in an idle state. Then, at the time of shunting the computing tasks, any target accelerator may choose to use the extended memory of other accelerator as a shared memory to increase the local read/write rate, or may choose to send the computing tasks to other accelerator for execution to share the computing workload, thereby speeding up the completion rate of the computing tasks.

The target accelerator shunting the computing tasks to the indirect-connected accelerator via the controller when the target accelerator is in the computing overload state in S303 may include: the target accelerator occupying the extended memory of the direct-connected accelerator and/or shunting the computing tasks to the direct-connected accelerator for execution when the target accelerator is in the computing overload state. The target accelerator shunting the computing tasks to the indirect-connected accelerator via the controller when the target accelerator is in the computing overload state in S303 may include: the target accelerator occupying an extended memory of the indirect-connected accelerator and/or shunting the computing tasks to the indirect-connected accelerator for execution via the controller when the target accelerator is in the computing overload state. That is, in addition to its own use, the extended memory of the first accelerator may be shared with the direct-connected accelerator or with other accelerators. At the same time of receiving sharing requests from a plurality of accelerators, the extended memory may be shared according to the priorities for local use, sharing for the direct-connected accelerator, and sharing for other accelerators.

According to the distributed computing method provided by the embodiment of the present application, by establishing the accelerator direct-connection pair on the basis of the information of the accelerators in the distributed accelerator cluster, the accelerator direct-connection pair at least includes one first accelerator that supports the computer express link protocol and/or two accelerators in the accelerator direct-connection pair have the same application computing logic. The direct connection between the accelerators is implemented outside the traditional routing subnetwork, and the computing tasks of the target accelerator in the computing overload state in the course of using a plurality of accelerators to perform parallel computing tasks may be shunted to the direct-connected accelerator through a direct-connection relationship or to the indirect-connected accelerator via the controller. In addition, the accelerators in the cluster share and occupy the extended memory of the accelerator that supports the computer express link protocol, and the performance of the accelerator in the distributed accelerator cluster that supports the computer express link protocol might be sufficiently exerted, thereby realizing an elastic memory and low-latency compute shunting of the accelerator cluster, and improving the parallel computing performance of the accelerator cluster.

An embodiment in a third aspect of the present application is described as follows.

Considering the scenario in which a controller for a multi-scenario computing task randomly arrives for the data distribution of the computing tasks, on the basis of the above embodiment, the embodiment of the present application provides a scheme for distributing the computing tasks based on the priorities, whereby the computing tasks are distributed to the target accelerator that is in an idle state and has an application computing logic matching the type of the corresponding computing tasks. In the distributed computing method provided by the embodiment of the present application, dividing the service task into computing tasks and distributing the computing tasks to the target accelerator having the application computing logic matching the type of the corresponding computing tasks and not being occupied in S303 may include:
dividing the service task into computing tasks, and assigning the computing tasks to the target accelerator in the following order of assignment priorities for the computing tasks:
the first assignment priority for the computing tasks is to assign the computing tasks to two accelerators in the accelerator direct-connection pair, wherein the accelerator direct-connection pair includes two idle first accelerators, the application computing logics of the two first accelerators both match the type of the corresponding computing tasks, and extended memories of the two first accelerators are not occupied;
the second assignment priority for the computing tasks is to assign the computing tasks to two accelerators in the accelerator direct-connection pair, wherein the accelerator direct-connection pair includes two idle first accelerators, the application computing logics of the two first accelerators match the type of the corresponding computing tasks, and the extended memory of one of the first accelerators is not occupied;
the third assignment priority for the computing tasks is to assign the computing tasks to two accelerators in the accelerator direct-connection pair, wherein the accelerator direct-connection pair includes one idle first accelerator and one idle second accelerator that does not support the computer express link protocol, the application computing logic of the first accelerator and the application computing logic of the second accelerator both match the type of the corresponding computing tasks, and the extended memory of the first accelerator is not occupied;
the fourth assignment priority for the computing tasks is to assign the computing tasks to two accelerators in the accelerator direct-connection pair, wherein the accelerator direct-connection pair includes two idle first accelerators, the application computing logics of the two first accelerators both match the type of the corresponding computing tasks, and the extended memories of the two first accelerators are occupied;
the fifth assignment priority for the computing tasks is to assign the computing tasks to two accelerators in the accelerator direct-connection pair, wherein the accelerator direct-connection pair includes two idle second accelerators, and the application computing logics of the two second accelerators match the type of the corresponding computing tasks;
the sixth assignment priority for the computing tasks is to assign the computing tasks to the target accelerator in the accelerator direct-connection pair, and only one of the two first accelerators in the accelerator direct-connection pair satisfies a condition of the target accelerator and an extended memory of the first accelerator is not occupied;
the seventh assignment priority for the computing tasks is to assign the computing tasks to the target accelerator in the accelerator direct-connection pair, wherein the accelerator direct-connection pair includes one first accelerator and one second accelerator, and only the first accelerator satisfies the condition of the target accelerator and the extended memory of the first accelerator is not occupied;
the eighth assignment priority for the computing tasks is to assign the computing tasks to one individual first accelerator that satisfies the condition of the target accelerator and whose extended memory is not occupied;
the ninth assignment priority for the computing tasks is to assign the computing tasks to the target accelerator in the accelerator direct-connection pair, wherein the accelerator direct-connection pair includes one first accelerator and one second accelerator, only the second accelerator satisfies the condition of the target accelerator and the extended memory of the first accelerator is not occupied;
the tenth assignment priority for the computing tasks is to assign the computing tasks to one individual first accelerator that satisfies the condition of the target accelerator and whose extended memory is occupied;
the eleventh assignment priority for the computing tasks is to assign the computing tasks to the target accelerator in the accelerator direct-connection pair, wherein the accelerator direct-connection pair includes one first accelerator and one second accelerator, only the second accelerator satisfies the condition of the target accelerator and the extended memory of the first accelerator is occupied; and
the twelfth assignment priority for the computing tasks is to assign the computing tasks to one individual second accelerator that satisfies the condition of the target accelerator.

In the above twelve computing task assignment priority sets, the first computing task has the highest assignment priority, followed by decreasing priorities, and the twelfth computing task has the lowest assignment priority.

It should be noted that if the controller assigns the computing tasks to the target accelerator (second accelerator) that does not support the computer express link protocol at the time of assigning the computing tasks initially, the extended memory might not be used, e.g., in the cases of the eleventh computing task assignment priority and the twelfth computing task assignment priority. When the extended memory of the direct-connected accelerator for the target accelerator ends the shared occupancy, the extended memory may be provided to the target accelerator as a shared memory for additional data storage and reading. Therefore, although the extended memory of the direct-connected accelerator for the target accelerator is occupied before, when the extended memory of the direct-connected accelerator is released, additional storage space might be provided, and the inter-kernel high-speed transmission link might be used as the shared memory of the target accelerator.

An embodiment in a fourth aspect of the present application is described as follows.

Based on the above embodiments, this embodiment of the present application further describes the control processes for the distribution of the computing tasks performed by the controller, the accelerator starting to execute the computing tasks, the accelerator ending the execution of the computing tasks, the occupancy and release of the extended memory of the accelerator, and the accelerator needing compute shunting.

The controller introduced in conjunction with the embodiment in the second aspect of the present application monitors real-time state information of the accelerators through the accelerator state information table (Table 1). At the time of distributing the data of the computing tasks to the target accelerator, the controller queries the corresponding real-time state information in the accelerator state information table corresponding to the target accelerator according to a network address of the target accelerator, and modifies a value of bit 0 # to 1, values of 4 #-7 # to values corresponding to application logic types, and values of 40 #-82 # to timestamps of the controller to distribute the computing tasks to the target accelerator. After any accelerator completes the computing tasks, this accelerator updates the real-time state information to the controller, and then the controller queries the accelerator state information table corresponding to the accelerator according to the network address of the accelerator, and modifies the value of bit 0 # to 0, values of 40 #-82 # to 0, and values of 83 #-125 # to timestamps of the accelerator to complete the computing tasks.

In combination with the scheme introduced in the embodiment of the second aspect of the present application in which the accelerator monitors the real-time state information of the accelerator to be shunted (which may be the direct-connected accelerator or the indirect-connected accelerator) through the compute shunting accelerator state information table (Table 2), when the target accelerator starts to execute the computing tasks, if there is a direct-connected accelerator for the target accelerator, the logic control sub-kernel of the target accelerator that is executing the computing tasks needs to inform the logic control sub-kernel of the direct-connected accelerator of the application computing logic type being executed, whether to support the computer express link protocol, whether the extended memory is in a shared occupation state, etc. After receiving the information about the target accelerator, the logic control sub-kernel of the direct-connected accelerator modifies a value of bit 0 # in an array field of the compute shunting accelerator state information table (denoted as a second compute shunting accelerator state information table) to 1 (i.e., the direct-connected target accelerator is in a task execution state). According to whether the target accelerator supports the computer express link protocol, the value of bit 1 # is set to a corresponding value, and values of bits 6 #-9 # are set to values corresponding to the logic type of the application computing sub-kernel of the target accelerator. According to whether the extended memory of the target accelerator is occupied, bit 4 # is set to a corresponding value. According to whether there is a direct-connected accelerator for the target accelerator, bit 74 # is set to a corresponding value.

In response to the target accelerator completing the computing tasks, if there is a direct-connected accelerator, the logic control sub-kernel of the target accelerator needs to inform the direct-connected accelerator whether the target accelerator has completed the computation, whether to support the computer express link protocol, the type of the supported application computing logic, whether the extended memory is in use, etc. The direct-connected accelerator modifies bits 0 #, 1 #, 4 # and 6 #-9 # in an array field of a local compute shunting accelerator state information table to corresponding values according to information notified by the target accelerator.

If the extended memory of any first accelerator is shared and occupied by the indirect-connected accelerator, the logic control sub-kernel of the first accelerator informs the direct-connected accelerator and the controller through the inter-kernel high-speed transmission link. The direct-connected accelerator modifies bit 4 # in the array field of the local compute shunting accelerator state information table to a corresponding value of 1, while the controller queries to find the accelerator state information table of the first accelerator according to the network address of the first accelerator to obtain the real-time state information of the first accelerator, and then modifies the value of bit 3 # to 1.

If the extended memory of any first accelerator is released at the end of occupancy, the logic control sub-kernel of the first accelerator informs the direct-connected accelerator and the controller through the inter-kernel high-speed transmission link. The direct-connected accelerator modifies the value of bit 4 # in the array field of the local compute shunting accelerator state information table to 0, while the controller queries to find the accelerator state information table of the first accelerator according to the network address of the first accelerator to obtain the real-time state information of the first accelerator, and then modifies the value of bit 3 # to 1. During this process, if the first accelerator is still in use, the first accelerator may directly invoke the extended memory for data storage and interaction.

In combination with the method introduced by the embodiment in the second aspect of the present application that the target accelerator determines whether the local memory is in the computing overload state, the target accelerator records a full occupation timestamp (denoted as T_{fstocpy}) when the local memory is fully occupied for the first time, and queries a local memory occupation state every query cycle (e.g., Δt); and determines the local memory to be in the computing overload state in the case that the local memory is still fully occupied for a continuous preset cycle (e.g., 3 cycles).

As described in the embodiment of the second aspect of the present application, when the target accelerator is in the computing overload state, if there is a condition to shunt the computing tasks to the direct-directed accelerator for the target accelerator, the computing tasks are preferentially shunted to the direct-connected accelerator; if there is no condition to shunt the computing tasks to the direct-connected accelerator, the target accelerator needs to send a shunting request to the controller, which selects an indirect-connected accelerator as the accelerator to be shunted for the target accelerator, whereby the target accelerator shunts the computing tasks to the indirect-connected accelerator.

In practical applications, the logic control sub-kernel of the target accelerator acquires the real-time state information of the accelerator to be shunted by querying the local compute shunting accelerator state information table, and the controller implements compute shunting of the target accelerator by querying the accelerator state information table of the accelerators after the controller sends the shunting request. Then, in the distributed computing method provided by the embodiment of the present application, when the target accelerator is in the computing overload state, the target accelerator shunting the computing tasks to the direct-connected accelerator for the target accelerator in the case that the target accelerator is in the computing overload state and the direct-connected accelerator for the target accelerator satisfies a condition that it is in an idle state and has the same application computing logic as that of the target accelerator may include:
in response to receiving the shunting request sent by the target accelerator in the computing overload state, querying to find an accelerator state information table corresponding to the target accelerator according to an identifier of the target accelerator; setting usage state information in the accelerator state information table corresponding to the direct-connected accelerator for the target accelerator to be non-idle, the start time to the time of the current timestamp, and the end time to 0 in the case that the information of the direct-connected accelerator for the target accelerator is found from the accelerator state information table corresponding to the target accelerator, and the accelerator state information table corresponding to the direct-connected accelerator for the target accelerator is found according to the identifier of the direct-connected accelerator for the target accelerator to determine that the direct-connected accelerator for the target accelerator is in an idle state and has the same application computing logic as that of the target accelerator;
feeding the information indicating that the direct-connected accelerator for the target accelerator satisfies a compute shunting condition back to the target accelerator, whereby the target accelerator shunts the computing tasks to the direct-connected accelerator for the target accelerator;
in response to receiving information indicating that the computing tasks sent by the target accelerator have been completed, querying to find the accelerator state information table corresponding to the target accelerator according to the identifier of the target accelerator, and setting the usage state information in the accelerator state information table corresponding to the target accelerator to be idle, the start time to 0, and the end time to the time of the current timestamp; and
in response to receiving information indicating that the computing tasks sent by the direct-connected accelerator for the target accelerator have been completed, querying to find an accelerator state information table corresponding to the direct-connected accelerator for the target accelerator according to the identifier of the direct-connected accelerator for the target accelerator; setting usage state information in the accelerator state information table corresponding to the direct-connected accelerator for the target accelerator to be idle, the start time to 0 and the end time to the time of the current timestamp.

In the above steps, the accelerator is in an idle state, which may mean only that the application computing sub-kernel of the accelerator is in an idle state, or that both the application computing sub-kernel of the accelerator and the extended memory of the accelerator are in an idle state, or at least one of them is in an idle state. Then, feeding the information indicating that the direct-connected accelerator for the target accelerator satisfies the compute shunting condition back to the target accelerator, whereby the target accelerator shunts the computing tasks to the direct-connected accelerator for the target accelerator may include:
feeding information indicating that the direct-connected accelerator for the target accelerator satisfies the compute shunting condition and that the extended memory is not occupied back to the target accelerator, whereby the target accelerator shunts the computing tasks to the direct-connected accelerator for the target accelerator for execution and/or share the extended memory of the direct-connected accelerator for the target accelerator, in the case that the direct-connected accelerator for the target accelerator is determined to be the first accelerator and the extended memory is not occupied according to the accelerator state information table corresponding to the direct-connected accelerator for the target accelerator; and
feeding information indicating that the direct-connected accelerator for the target accelerator satisfies the compute shunting condition back to the target accelerator, whereby the target accelerator shunts the computing tasks to the direct-connected accelerator for the target accelerator for execution, in the case that the direct-connected accelerator for the target accelerator is determined to be the second accelerator that does not support the computer express link protocol or the direct-connected accelerator for the target accelerator is the first accelerator, but the extended memory is occupied, according to the accelerator state information table corresponding to the direct-connected accelerator for the target accelerator.

However, if there is no condition to shunt the computing tasks to the direct-connected accelerator, the target accelerator sends the shunting request to the controller, which selects an indirect-connected accelerator as the accelerator to be shunted for the target accelerator, whereby the target accelerator shunts the computing tasks to the indirect-connected accelerator. Then, assigning the indirect-connected accelerator to the target accelerator as the accelerator to be shunted, whereby the target accelerator shunts the computing tasks to the accelerator to be shunted, in the case that the target accelerator is in the computing overload state and no direct-connected accelerator is provided for the target accelerator or the direct-connected accelerator for the target accelerator is in a non-idle state or the direct-connected accelerator for the target accelerator has different application computing logic from that of the target accelerator, includes:
in response to receiving the shunting request sent by the target accelerator in the computing overload state, querying to find the accelerator state information table corresponding to the target accelerator according to the identifier of the target accelerator; acquiring information of idle accelerators in the distributed accelerator cluster, selecting the accelerator that has an application computing logic matching the type of the corresponding computing tasks from the idle accelerators as the accelerator to be shunted, and setting usage state information in the accelerator state information table corresponding to the accelerator to be shunted to be non-idle, the start time to the time of the current timestamp, and the end time to 0, in the case that the information of the direct-connected accelerator for the target accelerator is not found in the accelerator state information table corresponding to the target accelerator, or that the information of the direct-connected accelerator for the target accelerator is found in the accelerator state information table corresponding to the target accelerator and the accelerator state information table corresponding to the direct-connected accelerator for the target accelerator is found according to the identifier of the direct-connected accelerator for the target accelerator to determine that the direct-connected accelerator for the target accelerator is in a non-idle state and has different application computing logic from that of the target accelerator;
feeding the information indicating that the accelerator to be shunted satisfies the compute shunting condition back to the target accelerator, whereby the target accelerator shunts the computing tasks to the accelerator to be shunted;
in response to receiving information indicating that the computing tasks sent by the target accelerator have been completed, querying to find the accelerator state information table corresponding to the target accelerator according to the identifier of the target accelerator, and setting the usage state information in the accelerator state information table corresponding to the target accelerator to be idle, the start time to 0, and the end time to the time of the current timestamp; and
in response to receiving information indicating that the computing tasks sent by the accelerator to be shunted have been completed, querying to find the accelerator state information table corresponding to the accelerator to be shunted according to the identifier of the accelerator to be shunted, and setting the usage state information in the accelerator state information table corresponding to the accelerator to be shunted to be idle, the start time to 0, and the end time to the time of the current timestamp.

In the above steps, the accelerator is in an idle state, which may mean only that the application computing sub-kernel of the accelerator is in an idle state, or that both the application computing sub-kernel of the accelerator and the extended memory of the accelerator are in an idle state, or at least one of them is in an idle state. Then, feeding the information indicating that the accelerator to be shunted satisfies the compute shunting condition back to the target accelerator, whereby the target accelerator shunts the computing tasks to the accelerator to be shunted may include:
feeding information indicating that the accelerator to be shunted satisfies the compute shunting condition and that the extended memory is not occupied back to the target accelerator, whereby the target accelerator shunts the computing tasks to the accelerator to be shunted for execution and/or share the extended memory of the accelerator to be shunted, in the case that the accelerator to be shunted is determined to be the first accelerator and the extended memory is not occupied according to the accelerator state information table corresponding to the accelerator to be shunted; and
feeding information indicating that the accelerator to be shunted satisfies the compute shunting condition back to the target accelerator, whereby the target accelerator shunts the computing tasks to the accelerator to be shunted for execution, in the case that the accelerator to be shunted is determined to be the second accelerator that does not support the computer express link protocol or the accelerator to be shunted is determined to be the first accelerator, but the extended memory is occupied, according to the accelerator state information table corresponding to the accelerator to be shunted.

An embodiment in a fifth aspect of the present application is described as follows.

In combination with the above embodiment of the present application, when the target accelerator needs to shunt the computing tasks, the target accelerator may choose to occupy the extended memory of another accelerator to increase its own read/write performance, or may shunt the computing tasks to another idle accelerator to be shunted having the same application computing logic as that of the target accelerator. However, in combination with the conditions about the usage state information of the accelerator, whether the accelerator supports the computer express link protocol, and whether the extended memory of the accelerator is occupied, a compute shunting strategy may be assigned to the target accelerator to improve the overall efficiency of executing the computing tasks.

Then, based on the above embodiment, this embodiment of the present application further describes actual cases in compute shunting of the target accelerator.

In Case I: if there is a direct-connected accelerator for the target accelerator, the direct-connected accelerator has the same application computing logic as that of the target accelerator, the direct-connected accelerator is in an idle state, the direct-connected accelerator supports the computer express link protocol and the extended memory of the direct-connected accelerator is not occupied. Then, the target accelerator in the computing overload state applies for the controller to shunt some computing tasks to the direct-connected accelerator and its extended memory through the inter-kernel high-speed transmission link.

After receiving related shunting information, the controller may first query the real-time state information of the direct-connected accelerator in the accelerator state information table corresponding to the direct-connected accelerator for the target accelerator according to the network address of the direct-connected accelerator, and modifies usage state information (i.e., modifying the value of bit 0 # to 1), the start time (i.e., setting values of bits 40 #-82 # to the current timestamp), and the end time (i.e., setting values of 83 #-125 # to 0) of the accelerators in the accelerator state information table corresponding to the direct-connected accelerator for the target accelerator. Then, a controller-side server notifies the target accelerator and the direct-connected accelerator via a network to shunt the computing task and to use the extended memory of the direct-connected accelerator. At the same time, in order to improve the usage efficiency of the extended memory and avoid frequent network data I/O between the target accelerator and the direct-connected accelerator, the extended memory of the direct-connected accelerator is only used by the target accelerator.

After completing the computing tasks, the target accelerator and the direct-connected accelerator may each transmit a computing result to a corresponding receiver through the network. Finally, after completing the computing tasks under assistance, on the one hand, the target accelerator and the direct-connected accelerator need to exchange local real-time state information with each other, and update the local compute shunting accelerator state information table according to the real-time state information of the direct-connected accelerator (in some embodiments referring to the description in the embodiment of the fourth aspect of the present application), and on the other hand, need to inform the controller of the information about the completion of the computing tasks through a network port. The controller queries and modifies usage state information in the corresponding accelerator state information table to an idle state, set the start time to 0 and the end time to a timestamp indicating the accelerator has completed the computing task (referring to the description in the embodiment of the fourth aspect of the present application) according to the real-time state information of the current target accelerator and the real-time state information of its direct-connected accelerator, and accordingly modifies the occupation information of the expanded memory.

In Case II: if there is a direct-connected accelerator for the target accelerator, the direct-connected accelerator has the same application computing logic as that of the target accelerator, the direct-connected accelerator is in an idle state, the direct-connected accelerator supports the computer express link protocol and the extended memory of the direct-connected accelerator is occupied. Then, the target accelerator in the computing overload state applies for the controller to shunt some computing tasks to the direct-connected accelerator through the inter-kernel high-speed transmission link, but the extended memory of the direct-connected accelerator that is being shared and occupied might not be used.

After receiving related shunting information, the controller may first query the real-time state information of the direct-connected accelerator in the accelerator state information table corresponding to the direct-connected accelerator for the target accelerator according to the network address of the direct-connected accelerator, and modifies usage state information (i.e., modifying the value of bit 0 # to 1), the start time (i.e., setting values of bits 40 #-82 # to the current timestamp), and the end time (i.e., setting values of 83 #-125 # to 0) of the accelerators in the accelerator state information table corresponding to the direct-connected accelerator for the target accelerator. Then, the controller-side server notifies the target accelerator and the direct-connected accelerator via a network to shunt the computing tasks, but not to use the extended memory of the direct-connected accelerator. In the case that the target accelerator and the direct-connected accelerator process the computing tasks, if the extended memory of the direct-connected accelerator is released, in order to improve the usage efficiency of the extended memory and avoid frequent network data I/O between the target accelerator and the direct-connected accelerator, the extended memory released by the direct-connected accelerator is preferentially used for the local memory to execute the computing tasks or may also be used by the target accelerator at the same time.

After completing the computing tasks, the target accelerator and the direct-connected accelerator may each transmit a computing result to a corresponding receiver through the network. Finally, after completing the computing tasks under assistance, on the one hand, the target accelerator and the direct-connected accelerator need to exchange local real-time state information with each other, and update the local compute shunting accelerator state information table according to the real-time state information of the direct-connected accelerator (in some embodiments referring to the description in the embodiment of the fourth aspect of the present application), and on the other hand, need to inform the controller of the information about the completion of the computing tasks through a network port. The controller queries and modifies usage state information in the corresponding accelerator state information table to an idle state, set the start time to 0 and the end time to a timestamp indicating the accelerator has completed the computing tasks (referring to the description in the embodiment of the fourth aspect of the present application) according to the real-time state information of the current target accelerator and the real-time state information of its direct-connected accelerator, and accordingly modifies the occupation information of the expanded memory.

In Case III: if there is a direct-connected accelerator for the target accelerator, the direct-connected accelerator has the same application computing logic as that of the target accelerator, the direct-connected accelerator is in a non-idle state and supports the computer express link protocol and the extended memory of the direct-connected accelerator is not occupied. Then, the target accelerator in the computing overload state may select two computing task shunting methods. In the first method, in order to avoid the I/O time caused by the target accelerator and the direct-connected accelerator that share the extended memory of the direct-connected accelerator, the target accelerator does not occupy the extended memory of the direct-connected accelerator, that is, the extended memory of the direct-connected accelerator is reserved for local use; and the target accelerator applies for the controller to shunt the computing tasks to the indirect-connected accelerator. In the other method, if the direct-connected accelerator is not in the computing overload state, the target accelerator may apply to occupy the extended memory of the direct-connected accelerator to improve the local read/write performance.

If the first method is adopted, the target accelerator sends a shunting request to the controller. After receiving the shunting request, the controller queries an accelerator list of the distributed accelerator cluster to obtain accelerators that have the same application computing logic as that of the target accelerator and are in an idle state as candidate shunting accelerators, and then the accelerator to be shunted is selected from the candidate shunting accelerators. In the event of selecting the accelerator to be shunted, it is preferable to select the candidate shunting accelerator that supports the computer express link protocol and the extended memory is not occupied. If the candidate shunting accelerator is in an idle state but the extended memory is occupied, the computing tasks may be shunted to the candidate shunting accelerator without occupying the extended memory of the candidate shunting accelerator. If the candidate shunting accelerator is in an non-idle but the extended memory is not occupied, the extended memory of the candidate shunting accelerator may be applied to be occupied, or the extended memory of the candidate shunting accelerator is preferentially used for local use. In order to further improve a load balancing effect, the controller selects an accelerator with the earliest end time (i.e., the longest idle time) as the accelerator to be shunted among the candidate shunting accelerators that support the computer express link protocol and the extended memory is not occupied.

After selecting the accelerator to be shunted, the controller may query the corresponding accelerator state information table according to the network address of the accelerator to be shunted, and modify usage state information (i.e., modifying the value of bit 0 # to 1), the start time (i.e., setting values of bits 40 #-82 # to the current timestamp), and the end time (i.e., setting values of 83 #-125 # to 0) in the accelerator state information table. Then, the controller notifies the target accelerator and the accelerator to be shunted via the network to shunt the computing tasks and to use the extended memory of the direct-connected accelerator. Alternatively, since the accelerator to be shunted is an indirect-connected accelerator, the controller notifies the target accelerator and the accelerator to be shunted through the network to shunt the computing tasks and not to use the extended memory of the accelerator to be shunted, whereby the extended memory of the accelerator to be shunted is only for its own use.

At the time of shunting the computing tasks, the target accelerator needs to modify its own compute shunting accelerator state information table, and modifies the value of bit 2 # to 1, 3 # to 0, 5 # to 0, and 10 #-41 # to the network address of the accelerator to be shunted.

After completing the computing tasks, the target accelerator and the accelerator to be shunted may each transmit a computing result to a corresponding receiver through the network. Finally, after completing the computing tasks through compute shunting, the two accelerators need to inform the controller of the relevant information through the network port. The controller, according to IP addresses of the two accelerators, queries and modifies usage state information in the corresponding accelerator state information table to an idle state, set the start time to 0 and the end time to a timestamp indicating that the accelerator has completed the computing tasks (referring to the description in the embodiment of the fourth aspect of the present application), and accordingly modifies the occupation information of the expanded memory.

In addition, if there is also a direct-connected accelerator for the accelerator to be shunted, the state interaction between the accelerator to be shunted and its direct-connected accelerator and the maintenance and update of the compute shunting accelerator state information table may refer to the description in the embodiment of the fourth aspect of the present application.

In Case IV: if there is a direct-connected accelerator for the target accelerator, the direct-connected accelerator has the same application computing logic as that of the target accelerator, the direct-connected accelerator is in a non-idle state, the direct-connected accelerator supports the computer express link protocol and the extended memory of the direct-connected accelerator is occupied. Then, the target accelerator in the computing overload state needs to shunt the computing tasks to the indirect-connected accelerator, which may in some embodiments refer to the shunting scheme in Case III in which the indirect-connected accelerator is regarded as the accelerator to be shunted and a maintenance scheme of the compute shunting accelerator state information table.

In Case V: if there is a direct-connected accelerator for the target accelerator, the direct-connected accelerator has different application computing logic from that of the target accelerator, the direct-connected accelerator is in an idle state, the direct-connected accelerator supports the computer express link protocol and the expanded memory of the direct-connected accelerator is not occupied. Then, the target accelerator in the computing overload state may apply to use the expanded memory of the direct-connected accelerator or apply for the controller to shunt the computing tasks to the indirect-connected accelerator.

If the target accelerator may apply to use the extended memory of the direct-connected accelerator, a detailed step is as follows:
the target accelerator sends a request to the controller to use the extended memory of the direct-connected accelerator. In response to receiving the request, the controller may query the real-time state information of the direct-connected accelerator in the accelerator state information table corresponding to the direct-connected accelerator for the target accelerator, and modify occupancy information (i.e., modifying the value of bit 3 # to 1) of the extended memory in the accelerator state information table corresponding to the direct-connected accelerator for the target accelerator. That is, the extended memory of the direct-connected accelerator is occupied by the target accelerator. Then, the controller notifies the target accelerator via the network to use the extended memory of the direct-connected accelerator. The target accelerator first modifies array fields in its computing shunt accelerator state table (i.e., modifies the value of bit 2 # to 1, the value of 3 # to 1, and the values of 10 #-41 # to the network address of the direct-connected accelerator. After the above operations are completed, the target accelerator might use the extended memory of the direct-connected accelerator to write and read the data of the computing tasks. The specific write paths are as follows: the on-chip memory buffer area of the target accelerator→the inter-kernel communication sub-kernel of the target accelerator→the inter-kernel high-speed transmission link between the target accelerator and the direct-connected accelerator→the inter-kernel communication sub-kernel of the direct-connected accelerator→the computer express link memory control sub-kernel of the direct-connected accelerator→the memory buffer of the direct-connected accelerator. The specific read path is the opposite to the write path.

The target accelerator and the direct-connected accelerator may each transmit a corresponding computing result to the corresponding receiver through the network. Finally, after completing the computing tasks under assistance, on the one hand, the target accelerator and the direct-connected accelerator need to exchange local real-time state information with each other, and update the local compute shunting accelerator state information table according to the real-time state information of the direct-connected accelerator (in some embodiments referring to the description in the embodiment of the fourth aspect of the present application), and on the other hand, need to inform the controller of the information about the completion of the computing tasks through a network port. The controller queries and modifies usage state information in the corresponding accelerator state information table to an idle state, sets the start time to 0 and the end time to a timestamp indicating the accelerator has completed the computing tasks (referring to the description in the embodiment of the fourth aspect of the present application) according to the real-time state information of the current target accelerator and the real-time state information of its direct-connected accelerator, and accordingly modifies the occupation information of the expanded memory.

If the controller is applied to allow the indirect-connected accelerator to shunt the computing tasks, it may in some embodiments refer to a shunting scheme in Case III in which the indirect-connected accelerator is regarded as the accelerator to be shunted and a maintenance scheme for the compute shunting accelerator state information table.

In Case VI: if there is a direct-connected accelerator for the target accelerator, the direct-connected accelerator has different application computing logic from that of the target accelerator, the direct-connected accelerator is in a non-idle state, the direct-connected accelerator supports the computer express link protocol, and the extended memory of the direct-connected accelerator is not occupied. Then, as described in Case III, the target accelerator in the computing overload state may select two computing task shunting methods. In one method, in order to avoid the I/O time caused by the target accelerator and the direct-connected accelerator that share the extended memory of the direct-connected accelerator, the target accelerator does not occupy the extended memory of the direct-connected accelerator, that is, the extended memory of the direct-connected accelerator is reserved for local use, and the target accelerator may apply for the controller to shunt the computing tasks to the indirect-connected accelerator. In the other method, when the direct-connected accelerator is not in the computing overload state, the target accelerator may apply to occupy the extended memory of the direct-connected accelerator to improve the local read/write performance. If the first method is adopted, it may in some embodiments refer to the shunting scheme in Case III in which the indirect-connected accelerator is regarded as the accelerator to be shunted and the maintenance scheme for the compute shunting accelerator state information table. If the second method is adopted, it may in some embodiments refer to the scheme in Case V in which the target accelerator applies to occupy the extended memory of the direct-connected accelerator and the maintenance scheme for the compute shunting accelerator state information table.

In Case VII: if there is a direct-connected accelerator for the target accelerator, the direct-connected accelerator has different application computing logic from that of the target accelerator, the direct-connected accelerator is in an idle state, the direct-connected accelerator supports the computer express link protocol but the extended memory of the direct-connected accelerator is occupied. Since the direct-connected accelerator has the different application computing logic from that the target accelerator, the target accelerator in the computing overload state might only shunt the computing tasks to the indirect-connected accelerator. At this time, it may in some embodiments refer to the shunting scheme in Case III in which the indirect-connected accelerator is regarded as the accelerator to be shunted and the maintenance scheme for the compute shunting accelerator state information table.

In Case VIII: if there is a direct-connected accelerator for the target accelerator, the direct-connected accelerator has different application computing logic from that of the target accelerator, the direct-connected accelerator is in a non-idle state, the direct-connected accelerator supports the computer express link protocol but the extended memory of the direct-connected accelerator is occupied. Since the direct-connected accelerator has the different application computing logic from that the target accelerator, the target accelerator in the computing overload state might only shunt the computing tasks to the indirect-connected accelerator. At this time, it may in some embodiments refer to the shunting scheme in Case III in which the indirect-connected accelerator is regarded as the accelerator to be shunted and the maintenance scheme for the compute shunting accelerator state information table.

In Case IX: if there is a direct-connected accelerator for the target accelerator, the direct-connected accelerator has the same application computing logic as that of the target accelerator, the direct-connected accelerator is in an idle state, but the direct-connected accelerator does not support the computer express link protocol. Then, the target accelerator in the computing overload state applies to shunt some computing tasks to the direct-connected accelerator through the inter-kernel high-speed transmission link.

After receiving related shunting information, the controller may first query the real-time state information of the direct-connected accelerator in the accelerator state information table corresponding to the direct-connected accelerator for the target accelerator according to the network address of the direct-connected accelerator, and modify usage state information (i.e., modifying the value of bit 0 # to 1), the start time (i.e., setting values of bits 40 #-82 # to the time of the current timestamp), and the end time (i.e., setting values of 83 #-125 # to 0) of the accelerators in the accelerator state information table corresponding to the direct-connected accelerator for the target accelerator. Then, a controller-side server notifies the target accelerator and the direct-connected accelerator via the network to shunt the computing task.

After completing the computing tasks, the target accelerator and the direct-connected accelerator may each transmit a computing result to a corresponding receiver through the network. Finally, after completing the computing tasks under assistance, on the one hand, the target accelerator and the direct-connected accelerator need to exchange local real-time state information with each other, and update the local compute shunting accelerator state information table according to the real-time state information of the direct-connected accelerator (in some embodiments referring to the description in the embodiment of the fourth aspect of the present application), and on the other hand, need to inform the controller of the information about the completion of the computing tasks through a network port. The controller queries and modifies usage state information in the corresponding accelerator state information table to an idle state, sets the start time to 0 and the end time to a timestamp indicating the accelerator has completed the computing tasks according to the real-time state information of the current target accelerator and the real-time state information of its direct-connected accelerator (in some embodiments referring to the description in the embodiment of the fourth aspect of the present application).

In Case X: if there is a direct-connected accelerator for the target accelerator, the direct-connected accelerator has the same application computing logic as that of the target accelerator, the direct-connected accelerator is in a non-idle state, and the direct-connected accelerator does not support the computer fast interconnection protocol. Then, the target accelerator in the computing overload state may only shunt the computing tasks to the indirect-connected accelerator. At this time, it may in some embodiments refer to the shunting scheme in Case III in which the indirect-connected accelerator is regarded as the accelerator to be shunted and the maintenance scheme for the compute shunting accelerator state information table.

In Case XI: if there is a direct-connected accelerator for the target accelerator, the direct-connected accelerator has different application computing logic from that of the target accelerator, and the direct-connected accelerator does not support the computer express link protocol. Regardless of whether the direct-connected accelerator is in an idle state, the target accelerator in the computing overload state needs to shunt the computing tasks to the indirect-connected accelerator. At this time, it may refer to the shunting scheme in Case III in which the indirect-connected accelerator is regarded as the accelerator to be shunted and the maintenance scheme for the compute shunting accelerator state information table.

In Case XII, if there is no direct-connected accelerator for the target accelerator, the target accelerator in the computing overload state needs to shunt the computing tasks to the indirect-connected accelerator, At this time, it may refer to the shunting scheme in Case III in which the indirect-connected accelerator is regarded as the accelerator to be shunted and the maintenance scheme for the compute shunting accelerator state information table.

An embodiment in a sixth aspect of the present application is described as follows.

The embodiments in the second to the fifth aspects of the present application illustrate the specific steps of the distributed computing method from the perspective of the controller of the distributed accelerator cluster, and in order to facilitate further understanding, this embodiment of the present application illustrates the distributed computing method from the perspective of the target accelerator in the distributed accelerator cluster.

The distributed computing method provided by this embodiment of the present application is applied to the target accelerator in the distributed accelerator cluster, and includes:
receiving and executing computing tasks divided and assigned by a controller of the distributed cluster according to a service task; and
shunting the computing tasks to a direct-connected accelerator or to an indirect-connected accelerator via the controller when being in a computing overload state,
wherein the target accelerator is an accelerator that is in an idle state and has an application computing logic matching the types of the corresponding computing tasks; the distributed accelerator cluster includes a pre-established accelerator direct-connection pair, wherein the accelerator direct-connection pair includes two accelerators that are directly connected to each other, and at least one of the two accelerators is a first accelerator that supports a computer express link protocol and has an extended memory, and/or the two accelerators have the same application computing logic.

It should be noted that the target accelerator in this embodiment of the present application is the same as that described in the embodiment of the first aspect of the present application, that is, the accelerator that assigns the computing tasks via the controller. Then, the target accelerator may be an accelerator in the distributed accelerator cluster that is in an idle state and has an application computing logic matching the type of the corresponding computing tasks. The target accelerator may be a first accelerator that supports the computer express link protocol and has an extended memory, or may also be a second accelerator that does not support the computer express link protocol.

Referring to Table 1 described in the embodiment of the second aspect of the present application, the target accelerator and the controller exchange local real-time state information for the controller to manage. Referring to Table 2 described in the embodiment of the second aspect of the present application, if the target accelerator needs to shunt the computing tasks, and if there is a direct-connected accelerator for the target accelerator, the target accelerator communicates the local real-time state information with the direct-connected accelerator, or an indirect-connected accelerator is assigned to the target accelerator via the controller as an accelerator to be shunted. The target accelerator acquires real-time state information of the accelerator to be shunted through the controller and records the real-time state information in the local state information table of the computing shunt accelerator.

In addition, the specific scheme of the target accelerator to realize virtualization and pooling may refer to the embodiment in the first aspect of the present application, and the specific steps for the target accelerator to execute the computing tasks and shunt the computing tasks may refer to the embodiments in the second to fifth aspects of the present application, which will not be repeated herein.

An embodiment in a seventh aspect of the present application is described as follows.

For further understanding, this embodiment of the present application illustrates the distributed computing method from the perspective of a distributed computing cluster including a distributed accelerator cluster and a controller. The distributed computing method provided by this embodiment of the present application includes:
a controller of the distributed accelerator cluster acquiring information of accelerators in the distributed accelerator cluster and establishing an accelerator direct-connection pair according to the information of the accelerators;
the controller dividing a service task into computing tasks and distributing the computing tasks to a target accelerator in response to receiving the service task; and
the target accelerator executing the computing tasks and shunting the computing tasks to a direct-connected accelerator or to an indirect-connected accelerator via the controller when the target accelerator is in an overload state,
wherein the target accelerator is an accelerator that is in an idle state and has an application computing logic matching the type of the corresponding computing tasks; the accelerator direct-connection pair includes two accelerators that are directly connected to each other, and at least one of the two accelerators is a first accelerator that supports a computer express link protocol and has an extended memory, and/or the two accelerators have the same application computing logic.

It should be noted that the steps for the controller to assign the computing tasks, assign the accelerator to be shunted to the target accelerator, and manage the state information of each accelerator in the embodiment of the present application may refer to the embodiment in the fifth aspect of the present application. In the embodiment of the present application, the target accelerator may be any accelerator in the distributed accelerator cluster that is assigned with the computing task because it has an application computing logic matching the type of the computing tasks and is in an idle state when the controller assigns the computing tasks. The specific scheme of the target accelerator to realize virtualization and pooling may refer to the embodiment in the first aspect of the present application. The specific steps for the target accelerator to execute the computing tasks and shunt the computing tasks may refer to the embodiments in the second to fifth aspects of the present application, which will not be repeated herein.

An embodiment in an eighth aspect of the present application is described as follows.

On the basis of the above embodiment, this embodiment of the present application provides a practical application scenario of the distributed computing method. The distributed computing scenario described in the embodiment of the present application is only one of application scenarios that might be provided by the embodiments of the present application, and does not represent that all embodiments of the present application are executed in this way, nor does it represent that there is only one application scenario.

For example, a routing subnetwork (numbered 0 #) managed by a controller is used. It is assembled that there are six accelerators in the distributed accelerator cluster under the routing subnetwork. It should be noted that if the accelerator uses FPGA, the FPGA that does not support the computer express link protocol currently includes F10A, PAC (Programmable Automation Controller) and other series of FPGA accelerator products, while the FPGA that supports the computer express link protocol includes F26A series, Agilex 7 and other FPGA accelerator series products. Of course, in practical applications, the accelerator in the embodiment of the present application is not necessarily FPGA, nor is it necessarily of product types listed above.

The first accelerator that supports the computer express link protocol and has an extended memory and the second accelerator that does not support the computer express link protocol respectively perform the division of logical function sub-kernels to be realized in combination with a kernel virtualization technology (in some embodiments referring to the description in the embodiment of the first aspect of the present application). In addition, if there are six accelerators in a 0 # routing subnetwork, the corresponding accelerator numbers are denoted as 0 #, 1 #, 2 #, 3 #, 4 #, and 5 #, respectively. The application computing sub-kernels of the six accelerators support a total of two application computing logic types, SqueezeNet and ResNet 50, which are sequentially denoted as 0 # and 1 # respectively. Details are shown in Table 3.

TABLE 3
Detailed information table of six accelerators
under the same routing subnetwork

| | Application computing | Whether to support |
|---|---|---|
| | logic type of application | computer express |
| Accelerator Nos. | computing sub-kernel | link protocol |
| 0# | 0# | Yes |
| 1# | 0# | Yes |
| 2# | 1# | Yes |
| 3# | 1# | No |
| 4# | 0# | Yes |
| 5# | 1# | No |

Based on the five-level priority direct-connection method provided in the embodiment of the present application, the corresponding direct-connection information is shown in Table 4. The 0 # and 1 # accelerators are the first accelerators having the same application computing logic type, and compared with the second accelerator, more computing task data stored and processed by the accelerator are needed because both accelerators have the assistance of the extended memories when the controller assigns the tasks. In addition, when any one of the two direct-connected accelerators needs compute shunting, the other first accelerator and the extended memory may both be used to undertake the shunting of more computing tasks.

In contrast, although the application computing logic types of the 2 # and 3 # accelerators are the same, only 2 # is the first accelerator. Therefore, both the computing task data that might be processed in the computing task assignment stage and the computing task data undertaken by the two direct-connected accelerators during the compute shunting are less than those of 0 # and 1 # of the first priority. In contrast, although the 4 # accelerator is the first accelerator, the application computing logic types of the 4 # and 5 # accelerators are different. Compared with the direct-connected 2 # and 3 # accelerators, when the 4 # accelerator is in an idle state and the extended memory is not shared and occupied, the 5 # accelerator might only use its extended memory for data storage and reading due to different application computing logics while seeking for the 4 # accelerator for compute shunting.

TABLE 4
Direct-connection information table of six accelerators
under the same routing subnetwork

| | Direct-connected | |
|---|---|---|
| Accelerator Nos. | accelerator Nos. | Matched priorities |
| 0# | 1# | First priority |
| 2# | 3# | Third priority |
| 4# | 5# | Fifth priority |

After the three accelerator direct-connection pairs are established, in the course of assigning the computing task data for the six idle accelerators under the routing subnetwork, the distribution of the corresponding computing tasks in the distributed accelerator cluster might be completed with reference to the twelve computing task assignment priority provided in the embodiment of the third aspect of the present application.

TABLE 5
Details of two types of computing tasks to be assigned

| Types of | Amounts of |
|---|---|
| computing tasks | computing task data |
| 0# | 200 GB |
| 1# | 150 GB |

It is assumed that Table 5 shows the amounts and types of the computing tasks. In addition, the amount of data in a single computing task is in the integer MB level, so the minimum unit of the computing tasks during splitting should be greater than MB. However, the average processing rate of the first accelerator and the second accelerator to computing data as well as sizes of the internal memory (e.g., DDR SDRAM) and the extended memory are shown in Table 6.

TABLE 6
DDR storage spaces, extended memory space capacities and
total memory storage capacities of six accelerators

| | DDR | Extended | Total | Average | |
|---|---|---|---|---|---|
| | storage | memory | memory | processing | Network |
| Accelerator | space | space | space | rate of | addresses of |
| Nos. | capacity | capacity | capacity | accelerators | accelerators |
| 0# | 32 GB | 64 GB | 96 GB | 4.0 GB/s | 1.0.0.1 |
| 1# | 32 GB | 64 GB | 96 GB | 4.0 GB/s | 1.0.0.2 |
| 2# | 32 GB | 64 GB | 96 GB | 4.0 GB/s | 1.0.0.3 |
| 3# | 32 GB | 0 GB | 32 GB | 1.0 GB/s | 1.0.0.4 |
| 4# | 32 GB | 64 GB | 96 GB | 4.0 GB/s | 1.0.0.5 |
| 5# | 32 GB | 0 GB | 32 GB | 1.0 GB/s | 1.0.0.6 |

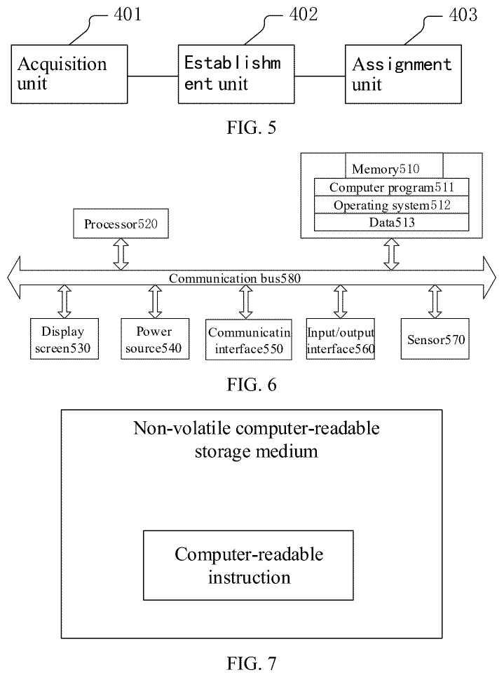

Combined with the direct connection of the six accelerators shown in FIG. 5, according to the twelve-level computing task assignment priority method provided in the embodiment of the third aspect of the present application, the amounts of the computing task data assigned by the six accelerators after the completion of the computing task distribution, the processing completion time without executing compute shunting and the matched priorities are obtained as shown in Table 7. It should be noted that when the above six accelerators start to execute the computing tasks and after the execution of the computing tasks, the controller provided in the embodiment of the fourth aspect of the present application modifies the accelerator state information table in response to completion of assignment of the computing tasks, and the accelerator completes the modification of the corresponding compute shunting accelerator state information table.

TABLE 7
Amounts of computing task data assigned by six accelerators in response
to completing the distribution of the computing tasks and the processing
completion duration without executing compute shunting

| | Amount of | Processing completion | Assignment |
|---|---|---|---|
| | assigned | duration without | priorities |
| Accelerator | computing | executing compute | of matched |
| Nos. | task data | shunting | computing tasks |
| 0# | 96 GB | 24 s | First priority |
| 1# | 96 GB | 24 s | First priority |
| 2# | 96 GB | 24 s | Third priority |
| 3# | 32 GB | 32 s | Third priority |
| 4# | 8 GB | 8 s | Seventh priority |
| 5# | 32 GB | 32 s | Ninth priority |

As shown in Table 7, the six accelerators have different durations to process the above computing tasks without executing compute shunting, which leads to the vacancy of some accelerators. In this regard, the relevant computing task shunting is completed with reference to computing task shunting modes in different scenarios introduced by the embodiments in the fourth and fifth aspects of the present application.

First of all, because the controller may implement parallel high-speed transmission of computing tasking data by using methods of a virtualization host and parallel simultaneous transmission of a plurality of high-speed network cards, taking the maximum length of computing task data that needs to be transmitted by 0 #, 1 # and 2 # accelerators being 96 GB as an example, when a data center uses a controller with a transmission bandwidth of 800 Gbps for execution, the required transmission duration is: 96*8/800=0.96 s. Taking the computing task data that needs to be transmitted by the 4 # accelerator and having the shortest transmission length of 8 GB as an example, when the data center adopts a controller with a transmission bandwidth of 800 Gbps for execution, the required transmission duration is: 8*8/800=0.08 s.

It should be noted that when the controller may achieve approximate simultaneous arrival of different computing tasks of the 0 #, 1 #, 2 # and 4 # accelerators by sending the computing task data that is sent to the 4 # accelerator in a delay of 0.96−0.08=0.88 s. It should be noted that while performing the distribution of the computing tasks, the controller will query to find the real-time state information of the corresponding accelerators according to network addresses of the accelerators, and modify the accelerator state information table (as shown in Table 8) according to the computing task shunting methods provided in different scenarios provided by the embodiments in the fourth and fifth aspects of the present application.

TABLE 8
Real-time state information table of six accelerators at the start time to execute compute task

| | | | | | Value | Value | Value | | |
|---|---|---|---|---|---|---|---|---|---|
| Accelerator | Value | Value | Value | Value | of 4#- | of 8#- | of 40#- | | |
| Nos. | of 0# | of 1# | of 2# | of 3# | 7# | 39# | 82# | 83#-125# | 126#-133# |
| 0# | 1 | 1 | 1 | 0 | 0000 | 0000000 | 0000000 | 0000000 | 0 |
| | | | | | | 1 | 0 | 0 | |
| | | | | | | 0000000 | 0000000 | 0000000 | |
| | | | | | | 0 | 0 | 0 | |
| | | | | | | 0000000 | 0000000 | 0000000 | |
| | | | | | | 0 | 0 | 0 | |
| | | | | | | 0000000 | 0000000 | 0000000 | |
| | | | | | | 1 | 0 | 0 | |
| | | | | | | | 0000000 | 0000000 | |
| | | | | | | | 0 | 0 | |
| | | | | | | | 000 | 000 | |
| 1# | 1 | 1 | 1 | 0 | 0000 | 0000000 | 0000000 | 0000000 | 0 |
| | | | | | | 1 | 0 | 0 | |
| | | | | | | 0000000 | 0000000 | 0000000 | |
| | | | | | | 0 | 0 | 0 | |
| | | | | | | 0000000 | 0000000 | 0000000 | |
| | | | | | | 0 | 0 | 0 | |
| | | | | | | 0000001 | 0000000 | 0000000 | |
| | | | | | | 0 | 0 | 0 | |
| | | | | | | | 0000000 | 0000000 | |
| | | | | | | | 0 | 0 | |
| | | | | | | | 000 | 000 | |
| 2# | 1 | 1 | 1 | 0 | 0001 | 0000000 | 0000000 | 0000000 | 0 |
| | | | | | | 1 | 0 | 0 | |
| | | | | | | 0000000 | 0000000 | 0000000 | |
| | | | | | | 0 | 0 | 0 | |
| | | | | | | 0000000 | 0000000 | 0000000 | |
| | | | | | | 0 | 0 | 0 | |
| | | | | | | 0000001 | 0000000 | 0000000 | |
| | | | | | | 1 | 0 | 0 | |
| | | | | | | | 0000000 | 0000000 | |
| | | | | | | | 0 | 0 | |
| | | | | | | | 000 | 000 | |
| 3# | 1 | 0 | 1 | 0 | 0001 | 0000000 | 0000000 | 0000000 | 0 |
| | | | | | | 1 | 0 | 0 | |
| | | | | | | 0000000 | 0000000 | 0000000 | |
| | | | | | | 0 | 0 | 0 | |
| | | | | | | 0000000 | 0000000 | 0000000 | |
| | | | | | | 0 | 0 | 0 | |
| | | | | | | 0000010 | 0000000 | 0000000 | |
| | | | | | | 0 | 0 | 0 | |
| | | | | | | | 0101000 | 0000000 | |
| | | | | | | | 0 | 0 | |
| | | | | | | | 000 | 000 | |
| 4# | 1 | 1 | 1 | 0 | 0000 | 0000000 | 0000000 | 0000000 | 0 |
| | | | | | | 1 | 0 | 0 | |
| | | | | | | 0000000 | 0000000 | 0000000 | |
| | | | | | | 0 | 0 | 0 | |
| | | | | | | 0000000 | 0000000 | 0000000 | |
| | | | | | | 0 | 0 | 0 | |
| | | | | | | 0000010 | 0000000 | 0000000 | |
| | | | | | | 1 | 0 | 0 | |
| | | | | | | | 0110111 | 0000000 | |
| | | | | | | | 0 | 0 | |
| | | | | | | | 000 | 000 | |
| 5# | 1 | 0 | 1 | 0 | 0001 | 0000000 | 0000000 | 0000000 | 0 |
| | | | | | | 1 | 0 | 0 | |
| | | | | | | 0000000 | 0000000 | 0000000 | |
| | | | | | | 0 | 0 | 0 | |
| | | | | | | 0000000 | 0000000 | 0000000 | |
| | | | | | | 0 | 0 | 0 | |
| | | | | | | 0000011 | 0000000 | 0000000 | |
| | | | | | | 0 | 0 | 0 | |
| | | | | | | | 0101000 | 0000000 | |
| | | | | | | | 0 | 0 | |
| | | | | | | | 000 | 000 | |

If it is assumed that the timestamps of 0 #, 1 #, 2 #, etc., which sent data packets earliest are Oms, that is, 0000000000000000000000000000000000000000000, the sending time of the accelerators 3 # and 5 # is: 0.96−32*8/800=0.64 s, that is, sending is performed when the value of 40 #-82 # is 0000000000000000000000000000000001010000000. Sending is performed when the corresponding timestamp of the accelerator 4 # is 0000000000000000000000000000000001101110000, i.e., at 0.88 s (880 ms). Further, according to the operations in the embodiments of the fourth aspect and the fifth aspect of the present application, when each direct-connected accelerator starts to execute the computing tasks, the corresponding compute shunting accelerator state information table is shown in Table 9.

TABLE 9
State information table of six accelerators to be shunted

| | | | | | | | Value | | | |
|---|---|---|---|---|---|---|---|---|---|---|
| Accelerator | Value | Value | Value | Value | Value | Value | of 6#- | | | |
| Nos. | of 0# | of 1# | of 2# | of 3# | of 4# | of 5# | 9# | 10#-41# | 42-73# | 74# |
| 0# | 1 | 1 | 0 | 0 | 0 | 0 | 0000 | 0000000 | 0000000 | 1 |
| | | | | | | | | 0 | 1 | |
| | | | | | | | | 0000000 | 0000000 | |
| | | | | | | | | 0 | 0 | |
| | | | | | | | | 0000000 | 0000000 | |
| | | | | | | | | 0 | 0 | |
| | | | | | | | | 0000000 | 0000001 | |
| | | | | | | | | 0 | 0 | |
| 1# | 1 | 1 | 0 | 0 | 0 | 0 | 0000 | 0000000 | 0000000 | 1 |
| | | | | | | | | 0 | 1 | |
| | | | | | | | | 0000000 | 0000000 | |
| | | | | | | | | 0 | 0 | |
| | | | | | | | | 0000000 | 0000000 | |
| | | | | | | | | 0 | 0 | |
| | | | | | | | | 0000000 | 0000000 | |
| | | | | | | | | 0 | 1 | |
| 2# | 1 | 0 | 0 | 0 | 0 | 0 | 0001 | 0000000 | 0000000 | 1 |
| | | | | | | | | 0 | 1 | |
| | | | | | | | | 0000000 | 0000000 | |
| | | | | | | | | 0 | 0 | |
| | | | | | | | | 0000000 | 0000000 | |
| | | | | | | | | 0 | 0 | |
| | | | | | | | | 0000000 | 0000010 | |
| | | | | | | | | 0 | 0 | |
| 3# | 1 | 1 | 0 | 0 | 0 | 0 | 0001 | 0000000 | 0000000 | 1 |
| | | | | | | | | 0 | 1 | |
| | | | | | | | | 0000000 | 0000000 | |
| | | | | | | | | 0 | 0 | |
| | | | | | | | | 0000000 | 0000000 | |
| | | | | | | | | 0 | 0 | |
| | | | | | | | | 0000000 | 0000001 | |
| | | | | | | | | 0 | 1 | |
| 4# | 1 | 0 | 0 | 0 | 0 | 0 | 0000 | 0000000 | 0000000 | 1 |
| | | | | | | | | 0 | 1 | |
| | | | | | | | | 0000000 | 0000000 | |
| | | | | | | | | 0 | 0 | |
| | | | | | | | | 0000000 | 0000000 | |
| | | | | | | | | 0 | 0 | |
| | | | | | | | | 0000000 | 0000011 | |
| | | | | | | | | 0 | 0 | |
| 5# | 1 | 1 | 0 | 0 | 0 | 0 | 0001 | 0000000 | 0000000 | 1 |
| | | | | | | | | 0 | 0 | |
| | | | | | | | | 0000000 | 0000000 | |
| | | | | | | | | 0 | 0 | |
| | | | | | | | | 0000000 | 0000000 | |
| | | | | | | | | 0 | 0 | |
| | | | | | | | | 0000000 | 0000010 | |
| | | | | | | | | 0 | 1 | |

As shown in Table 7, after the controller completes the distribution of the computing tasks, the six accelerators are each in a state where DDR of the internal memory is occupied, in response to receiving the computing task data. Related compute shunting is completed in combination with the compute task shunting methods under different scenarios as provided by the embodiments in the fourth aspect and the fifth aspect of the present application. Combined with the sending time of the previous six accelerators, it might be seen that the timestamp of all computing task data to reach the DDR of the internal memory is 0.96 s. That is, the value of the full occupation timestamp T_{fstocpy} is 0.96. Assuming that the value of the query cycle Δt is 9, combined with Table 7, it might be seen that after 9*3=27 s, 0 #, 1 #, 2 #, and 4 # accelerators are all in the process of loading after computing completion, while the remaining computing data in 3 # and 5 # accelerators is 32-27*1.0=5.0 GB. By comparing the data in Table 6, it might be seen that the accelerators are not in the computing overload state.

In order to describe the specific compute shunting process in detail, it is assumed that the 3 # accelerator is in a state where the controller distributes tasks, that is, the DDR of the internal memory is fully loaded, before 27 s+0.96 s=27.96 s. However, when the timestamp is 27.96 s, no more computing task data arrives. Then, taking the compute shunting of the 3 # accelerator as an example, since the 3 # accelerator is directly connected to the 2 # accelerator and has the same application logic type as that of the 2 # accelerator, and the 2 # accelerator is in an idle state and supports the computer express link protocol but the extended memory is not occupied, the corresponding operation might be completed in accordance with the steps in the Case I described in the embodiment of the fifth aspect of the present application.

First, the 3 # accelerator may query to find the network address of the direct-connected accelerator through the compute shunting accelerator state information table, and then request the controller to use the 2 # accelerator and its extended memory. After receiving the request, the controller will modify the real-time state information (i.e., a value of bit 0 # is modified to 1) of the 2 # accelerator in the table, the start time (i.e., the values of bits 40 #-82 # are set to the current timestamp), and the corresponding end time (i.e., the values of bits 83 #-125 # are set to 0). Then, the controller notifies the 3 # accelerator and the 2 # accelerator through the network to shunt the computing tasks and use the extended memories. At the same time, in order to improve the usage efficiency of the extended memory and avoid frequent network data I/O between the 3 # accelerator and the 2 # accelerator, the extended memory is only available to the 2 # accelerator where it is located. The two direct-connected accelerators may each transmit a corresponding computing result to a corresponding receiver through the network. Finally, after completing the computing tasks under assistance, on the one hand, the two accelerators need to complete the update of the compute shunting accelerator state information table according to the real-time state information of the accelerator to be shunt as described in the embodiment of the fourth aspect of the present application, and on the other hand, need to inform the controller of related information through the network port. According to the network address of the 3 # accelerator and the network address of the 2 # accelerator, the controller queries and modifies the usage state information and extended memory sharing information, modify the start time to 0, and write the corresponding end time.

It should be noted that because the compute shunting method needs to be designed according to actual services, the traditional dichotomy method is adopted in the embodiment of the present application. That is, at 27 s, the remaining amount of computing task data of the 3 # accelerator is 32 GB. 32 GB/2=16 GB is used. 16 GB of computing task data is transmitted to the 2 # accelerator. For example, an optical interface of a FPGA accelerator supports a transmission rate of 800 Gbps in the inter-kernel high-speed transmission link, and the arrival time is about 16*8/800=0.16 s, that is, 160 ms. It should be noted that the interaction time between the two direct-connected accelerators and the controller are ignored here. This is due to the fact that the amount of data (only the network addresses and modification instructions of the two accelerators) and the hash table processing time are very fast, so they are ignorable. However, the processing time of the 2 # accelerator is 16/4.0=4 s. Therefore, the completion timestamp of the computing task is 27 s+0.16 s+4 s+0.96 s=32.12 s. However, the processing time of the 3 # accelerator is 16/1.0=16 s. The completion timestamp of the computing task is 27 s+16 s+0.96 s=43.96 s. In addition, the completion timestamp of the computing task of the 0 # and 1 # accelerators is: 24 s+0.96 s=24.96 s. Similarly, the completion timestamp of the computing task of 4 # is: 8 s+0.96 s=8.96 s. The completion timestamp of the computing task of 5 # is: 32 s+0.96 s=32.96 s.

Therefore, the accelerator state information table of six accelerators of the controller after all computing tasks are completed at the timestamp of 43.96 s is shown in Table 10.

TABLE 10
Accelerator state information table of six accelerators
after all computing tasks are completed

| | | | | | Value | Value | Value | | |
|---|---|---|---|---|---|---|---|---|---|
| Accelerator | Value | Value | Value | Value | of 4#- | of 8#- | of 40#- | 83#- | 126#- |
| Nos. | of 0# | of 1# | of 2# | of 3# | 7# | 39# | 82# | 125# | 133# |
| 0# | 0 | 1 | 1 | 0 | 0000 | 0000000 | 0000000 | 0000000 | 0 |
| | | | | | | 1 | 0 | 0 | |
| | | | | | | 0000000 | 0000000 | 0000000 | |
| | | | | | | 0 | 0 | 0 | |
| | | | | | | 0000000 | 0000000 | 0000000 | |
| | | | | | | 0 | 0 | 0 | |
| | | | | | | 0000000 | 0000000 | 0000110 | |
| | | | | | | 1 | 0 | 0 | |
| | | | | | | | 0000000 | 0011000 | |
| | | | | | | | 0 | 0 | |
| | | | | | | | 000 | 000 | |
| 1# | 0 | 1 | 1 | 0 | 0000 | 0000000 | 0000000 | 0000000 | 0 |
| | | | | | | 1 | 0 | 0 | |
| | | | | | | 0000000 | 0000000 | 0000000 | |
| | | | | | | 0 | 0 | 0 | |
| | | | | | | 0000000 | 0000000 | 0000000 | |
| | | | | | | 0 | 0 | 0 | |
| | | | | | | 0000001 | 0000000 | 0000110 | |
| | | | | | | 0 | 0 | 0 | |
| | | | | | | | 0000000 | 0011000 | |
| | | | | | | | 0 | 0 | |
| | | | | | | | 000 | 000 | |
| 2# | 0 | 1 | 1 | 0 | 0001 | 0000000 | 0000000 | 0000000 | 0 |
| | | | | | | 1 | 0 | 0 | |
| | | | | | | 0000000 | 0000000 | 0000000 | |
| | | | | | | 0 | 0 | 0 | |
| | | | | | | 0000000 | 0000000 | 0000000 | |
| | | | | | | 0 | 0 | 0 | |
| | | | | | | 0000001 | 0000000 | 0000111 | |
| | | | | | | 1 | 0 | 1 | |
| | | | | | | | 0000000 | 1010111 | |
| | | | | | | | 0 | 1 | |
| | | | | | | | 000 | 000 | |
| 3# | 0 | 0 | 1 | 0 | 0001 | 0000000 | 0000000 | 0000000 | 0 |
| | | | | | | 1 | 0 | 0 | |
| | | | | | | 0000000 | 0000000 | 0000000 | |
| | | | | | | 0 | 0 | 0 | |
| | | | | | | 0000000 | 0000000 | 0000000 | |
| | | | | | | 0 | 0 | 0 | |
| | | | | | | 0000010 | 0000000 | 0001010 | |
| | | | | | | 0 | 0 | 1 | |
| | | | | | | | 0000000 | 0111011 | |
| | | | | | | | 0 | 1 | |
| | | | | | | | 000 | 000 | |
| 4# | 0 | 1 | 1 | 0 | 0000 | 0000000 | 0000000 | 0000000 | 0 |
| | | | | | | 1 | 0 | 0 | |
| | | | | | | 0000000 | 0000000 | 0000000 | |
| | | | | | | 0 | 0 | 0 | |
| | | | | | | 0000000 | 0000000 | 0000000 | |
| | | | | | | 0 | 0 | 0 | |
| | | | | | | 0000010 | 0000000 | 0000010 | |
| | | | | | | 1 | 0 | 0 | |
| | | | | | | | 0000000 | 0110000 | |
| | | | | | | | 0 | 0 | |
| | | | | | | | 000 | 000 | |
| 5# | 0 | 0 | 1 | 0 | 0001 | 0000000 | 0000000 | 0000000 | 0 |
| | | | | | | 1 | 0 | 0 | |
| | | | | | | 0000000 | 0000000 | 0000000 | |
| | | | | | | 0 | 0 | 0 | |
| | | | | | | 0000000 | 0000000 | 0000000 | |
| | | | | | | 0 | 0 | 0 | |
| | | | | | | 0000011 | 0000000 | 0001000 | |
| | | | | | | 0 | 0 | 0 | |
| | | | | | | | 0000000 | 0001100 | |
| | | | | | | | 0 | 0 | |
| | | | | | | | 000 | 000 | |

Then, the 3 # accelerator needs to complete the computing tasks at a timestamp of 27 s+32/1.0+0.96=59.96 s before shunting, and the saved calculation time after shunting is 59.96-43.96=16 s. The saved time efficiency is: 16/59.96=26.68%. It might be seen that the distributed computing method provided in the embodiment of the present application might fully improve the computing efficiency in practical application scenarios.

Various embodiments corresponding to the distributed computing system and the distributed computing method are described above. On this basis, the present application further discloses a distributed computing apparatus and device and a non-volatile computer-readable storage medium corresponding to the above system and method.

An embodiment in a ninth aspect of the present application is described as follows.

FIG. 5 is a schematic structural diagram of a distributed computing apparatus provided by an embodiment of the present application.

As shown in FIG. 5, the distributed computing apparatus provided by the embodiment of the present application is applied to a controller of a distributed accelerator cluster and includes:
an acquisition unit 401, configured to acquire information of accelerators in the distributed accelerator cluster;
an establishment unit 402, configured to establish an accelerator direct-connection pair according to the information of the accelerators; and
an assignment unit 403, configured to, in response to receiving a service task, divide the service task into computing tasks and distribute the computing tasks to an idle target accelerator having an application computing logic matching the type of the corresponding computing tasks, whereby the target accelerator executes the computing tasks and shunts the computing tasks to a direct-connected accelerator or to an indirect-connected accelerator via the controller when the target accelerator is in a computing overload state,
wherein the accelerator direct-connection pair includes two accelerators that are directly connected to each other, and at least one of the two accelerators is a first accelerator that supports a computer express link protocol and has an extended memory, and/or the two accelerators have the same application computing logic.

In some embodiments, the target accelerator shunting the computing tasks to the direct-connected accelerator when the target accelerator is in the computing overload state includes:
the target accelerator occupying the extended memory of the direct-connected accelerator and/or shunting the computing tasks to the direct-connected accelerator for execution when the target accelerator is in the computing overload state; and
the target accelerator shunting the computing tasks to the indirect-connected accelerator via the controller when the target accelerator is in the computing overload state includes:
the target accelerator occupying an extended memory of the indirect-connected accelerator and/or shunting the computing tasks to the indirect-connected accelerator for execution via the controller when the target accelerator is in the computing overload state.

In some embodiments, the establishment unit 402 establishing the accelerator direct-connection pair according to the information of the accelerators includes:
dividing the accelerators in the distributed accelerator cluster and establishing the accelerator direct-connection pair, by taking the accelerator direct-connection pair assembled by two first accelerators having the same application computing logic as a first priority, the accelerator direct-connection pair assembled by one first accelerator and one second accelerator that does not support the computer express link protocol and has the same application computing logic as that of the first accelerator as a second priority, the accelerator direct-connection pair assembled by two second accelerators having the same application computing logic as a third priority, the accelerator direct-connection pair assembled by two first accelerators having different application computing logics as a fourth priority, and the accelerator direct-connection pair assembled by one first accelerator and one second accelerator having different application computing logics as a fifth priority.

In some embodiments, the assignment unit 403 dividing the service task into computing tasks and distributing the computing tasks to the target accelerator having an application computing logic matching the type of the corresponding computing tasks and not being occupied includes:
selecting the target accelerator according to at least one of a direct-connection relationship and extended memory occupation, dividing the service task into the computing tasks and distributing the computing tasks to the target accelerator.

In some embodiments, the assignment unit 403 dividing the service task into the computing tasks and distributing the computing tasks to the target accelerator having an application computing logic matching the type of the corresponding computing tasks and not being occupied includes:
dividing the service task into the computing tasks, and assigning the computing tasks to the target accelerator in the following order of assignment priorities for the computing tasks:
the first assignment priority for the computing tasks is to assign the computing tasks to two accelerators in the accelerator direct-connection pair, wherein the accelerator direct-connection pair includes two idle first accelerators, the application computing logics of the two first accelerators match the types of the computing tasks, and extended memories of the two first accelerators are not occupied;
the second assignment priority for the computing tasks is to assign the computing tasks to two accelerators in the accelerator direct-connection pair, wherein the accelerator direct-connection pair includes two idle first accelerators, the application computing logics of the two first accelerators match the types of the computing tasks, and the extended memory of one of the first accelerators is occupied;
the third assignment priority for the computing tasks is to assign the computing tasks to two accelerators in the accelerator direct-connection pair, wherein the accelerator direct-connection pair includes one idle first accelerator and one idle second accelerator that does not support the computer express link protocol, the application computing logic of the first accelerator and the application computing logic of the second accelerator match the types of the computing tasks, and the extended memory of the first accelerator is not occupied;
the fourth assignment priority for the computing tasks is to assign the computing tasks to two accelerators in the accelerator direct-connection pair, wherein the accelerator direct-connection pair includes two idle first accelerators, the application computing logics of the two first accelerators match the types of the computing tasks, and the extended memories of the two first accelerators are occupied;
the fifth assignment priority for the computing tasks is to assign the computing tasks to two accelerators in the accelerator direct-connection pair, wherein the accelerator direct-connection pair includes two idle second accelerators, and the application computing logics of the two second accelerators match the types of the computing tasks;
the sixth assignment priority for the computing tasks is to assign the computing tasks to the target accelerator in the accelerator direct-connection pair, and only one of the two first accelerators in the accelerator direct-connection pair satisfies a condition of the target accelerator and the extended memory of the first accelerator is not occupied;
the seventh assignment priority for the computing tasks is to assign the computing tasks to the target accelerator in the accelerator direct-connection pair, wherein the accelerator direct-connection pair includes one first accelerator and one second accelerator, and only the first accelerator satisfies the condition of the target accelerator and the extended memory of the first accelerator is not occupied;
the eighth assignment priority for the computing tasks is to assign the computing tasks to one individual first accelerator that satisfies the condition of the target accelerator and whose extended memory is not occupied;
the ninth assignment priority for the computing tasks is to assign the computing tasks to the target accelerator in the accelerator direct-connection pair, wherein the accelerator direct-connection pair includes one first accelerator and one second accelerator, only the second accelerator satisfies the condition of the target accelerator and the extended memory of the first accelerator is not occupied;
the tenth assignment priority for the computing tasks is to assign the computing tasks to one individual first accelerator that satisfies the condition of the target accelerator and whose extended memory is occupied;
the eleventh assignment priority for the computing tasks is to assign the computing tasks to the target accelerator in the accelerator direct-connection pair, wherein the accelerator direct-connection pair includes one first accelerator and one second accelerator, and only the second accelerator satisfies the condition of the target accelerator and the extended memory of the first accelerator is occupied; and
the twelfth assignment priority for the computing tasks is to assign the computing tasks to one individual second accelerator that satisfies the condition of the target accelerator.

In some embodiment, the target accelerator performing the computing tasks and shunting the computing tasks to the direct-connected accelerator or to the indirect-connected accelerator via the controller when the target accelerator is performing the computing tasks and in a computing overload state includes:
the target accelerator shunting the computing tasks to the direct-connected accelerator for the target accelerator in the case that the target accelerator is in the computing overload state and the direct-connected accelerator for the target accelerator satisfies a condition that it is in an idle state and has the same application computing logic as that of the target accelerator; and
assigning the indirect-connected accelerator to the target accelerator as an accelerator to be shunted, whereby the target accelerator shunts the computing tasks to the accelerator to be shunted, in the case that the target accelerator is in the computing overload state and no direct-connected accelerator is provided for the target accelerator or the direct-connected accelerator for the target accelerator is in a non-idle state or the direct-connected accelerator for the target accelerator has different application computing logic from that of the target accelerator.

In some embodiments, the target accelerator shunting the computing tasks to the direct-connected accelerator for the target accelerator in the case that the target accelerator is in the computing overload state and the direct-connected accelerator for the target accelerator satisfies a condition that it is in an idle state and has the same application computing logic as that of the target accelerator includes:
in response to receiving a shunting request sent by the target accelerator in the computing overload state, querying to find an accelerator state information table corresponding to the target accelerator according to an identifier of the target accelerator; setting usage state information in the accelerator state information table corresponding to the direct-connected accelerator for the target accelerator to be non-idle, the start time to the time of the current timestamp, and the end time to 0 in the case that the information of the direct-connected accelerator for the target accelerator is found from the accelerator state information table corresponding to the target accelerator, and the accelerator state information table corresponding to the direct-connected accelerator for the target accelerator is found according to the identifier of the direct-connected accelerator for the target accelerator to determine that the direct-connected accelerator for the target accelerator is in an idle state and has the same application computing logic as that of the target accelerator;
feeding the information indicating that the direct-connected accelerator for the target accelerator satisfies a compute shunting condition back to the target accelerator, whereby the target accelerator shunts the computing tasks to the direct-connected accelerator for the target accelerator;
in response to receiving information indicating that the computing tasks sent by the target accelerator have been completed, querying to find the accelerator state information table corresponding to the target accelerator according to the identifier of the target accelerator, and setting the usage state information in the accelerator state information table corresponding to the target accelerator to be idle, the start time to 0, and the end time to the time of the current timestamp; and
in response to receiving information indicating that the computing tasks sent by the direct-connected accelerator for the target accelerator have been completed, querying to find an accelerator state information table corresponding to the direct-connected accelerator for the target accelerator according to the identifier of the direct-connected accelerator for the target accelerator; and setting usage state information in the accelerator state information table corresponding to the direct-connected accelerator for the target accelerator to be idle, the start time to 0 and the end time to the time of the current timestamp.

In some embodiments, feeding the information indicating that the direct-connected accelerator for the target accelerator satisfies a compute shunting condition back to the target accelerator, whereby the target accelerator shunts the computing tasks to the direct-connected accelerator for the target accelerator includes:
feeding information indicating that the direct-connected accelerator for the target accelerator satisfies the compute shunting condition and that the extended memory is not occupied back to the target accelerator, whereby the target accelerator shunts the computing tasks to the direct-connected accelerator for the target accelerator for execution and/or share the extended memory of the direct-connected accelerator for the target accelerator, in the case that the direct-connected accelerator for the target accelerator is determined to be the first accelerator and the extended memory is not occupied according to the accelerator state information table corresponding to the direct-connected accelerator for the target accelerator; and
feeding information indicating that the direct-connected accelerator for the target accelerator satisfies the compute shunting condition back to the target accelerator, whereby the target accelerator shunts the computing tasks to the direct-connected accelerator for the target accelerator for execution, in the case that the direct-connected accelerator for the target accelerator is determined to be the second accelerator that does not support the computer express link protocol or the direct-connected accelerator for the target accelerator is the first accelerator, but the extended memory is occupied, according to the accelerator state information table corresponding to the direct-connected accelerator for the target accelerator.

In some embodiments, assigning the indirect-connected accelerator to the target accelerator as the accelerator to be shunted, whereby the target accelerator shunts the computing tasks to the accelerator to be shunted, in the case that the target accelerator is in the computing overload state and no direct-connected accelerator is provided for the target accelerator or the direct-connection accelerator for the target accelerator is in a non-idle state or the direct-connected accelerator for the target accelerator has different application computing logic from that of the target accelerator includes:
in response to receiving the shunting request sent by the target accelerator in the computing overload state, querying to find the accelerator state information table corresponding to the target accelerator according to the identifier of the target accelerator; acquiring information of idle accelerators in the distributed accelerator cluster, selecting the accelerator that has an application computing logic matching the type of the corresponding computing tasks from the idle accelerators as the accelerator to be shunted, and setting usage state information in the accelerator state information table corresponding to the accelerator to be shunted to be non-idle, the start time to the time of the current timestamp, and the end time to 0, in the case that the information of the direct-connected accelerator for the target accelerator is not found in the accelerator state information table corresponding to the target accelerator, or that the information of the direct-connected accelerator for the target accelerator is found in the accelerator state information table corresponding to the target accelerator and the accelerator state information table corresponding to the direct-connected accelerator for the target accelerator is found according to the identifier of the direct-connected accelerator for the target accelerator to determine that the direct-connected accelerator for the target accelerator is in a non-idle state or has different application computing logic from that of the target accelerator;
feeding the information indicating that the accelerator to be shunted satisfies the compute shunting condition back to the target accelerator, whereby the target accelerator shunts the computing tasks to the accelerator to be shunted;
in response to receiving information indicating that the computing tasks sent by the target accelerator have been completed, querying to find the accelerator state information table corresponding to the target accelerator according to the identifier of the target accelerator, and setting the usage state information in the accelerator state information table corresponding to the target accelerator to be idle, the start time to 0, and the end time to the time of the current timestamp; and
in response to receiving information indicating that the computing tasks sent by the accelerator to be shunted have been completed, querying to find the accelerator state information table corresponding to the accelerator to be shunted according to the identifier of the accelerator to be shunted, and setting the usage state information in the accelerator state information table corresponding to the accelerator to be shunted to be idle, the start time to 0, and the end time to the time of the current timestamp.

In some embodiments, feeding the information indicating that the accelerator to be shunted satisfies the compute shunting condition back to the target accelerator, whereby the target accelerator shunts the computing tasks to the accelerator to be shunted includes:
feeding information indicating that the accelerator to be shunted satisfies the compute shunting condition and that the extended memory is not occupied back to the target accelerator, whereby the target accelerator shunts the computing tasks to the accelerator to be shunted for execution and/or share the extended memory of the accelerator to be shunted, in the case that the accelerator to be shunted is determined to be the first accelerator and the extended memory is not occupied according to the accelerator state information table corresponding to the accelerator to be shunted; and
feeding information indicating that the accelerator to be shunted satisfies the compute shunting condition back to the target accelerator, whereby the target accelerator shunts the computing tasks to the accelerator to be shunted for execution, in the case that the accelerator to be shunted is determined to be the second accelerator that does not support the computer express link protocol or the accelerator to be shunted is determined to be the first accelerator, but the extended memory is occupied, according to the accelerator state information table corresponding to the accelerator to be shunted.

In some embodiments, the two accelerators in the accelerator direct-connection pair share local application computing logic types, usage state information, whether to support the computer express link protocol and whether to occupy the extended memories through a direct-connected channel, and record the information of the direct-connected accelerator to a direct-connected accelerator state information table.

In some embodiments, the target accelerator, while shunting the computing tasks to the indirect-connected accelerator via the controller, receives information of the accelerator to be shunted sent by the controller, and record the information into the state information table of the accelerator to be shunted.

In some embodiments, the establishment unit 402 establishing the accelerator direct-connection pair includes:
establishing the accelerator direct-connection pair by applying an inter-kernel communication protocol; and
the target accelerator shunting the computing tasks to the direct-connected accelerator includes:
the target accelerator shunting the computing tasks to the direct-connected accelerator for the target accelerator on the basis of an inter-kernel high-speed transmission link.

In some embodiments, the target accelerator shunting the computing tasks to the indirect-connected accelerator via the controller includes:
receiving a shunting request sent by the target accelerator;
determining the accelerator to be shunted on the basis of the shunting request; and
sending the information of the accelerator to be shunted to the target accelerator, whereby the target accelerator shunts the computing tasks to the accelerator to be shunted via a routing subnetwork.

In some embodiments, the target accelerator shunting the computing tasks to the accelerator to be shunted via the routing subnetwork includes:
the target accelerator shunting the computing tasks to the accelerator to be shunted via the routing subnetwork on the basis of a RDMA protocol.

In some embodiments, determining the accelerator to be shunted on the basis of the shunting request includes:
acquiring an accelerator list of the distributed accelerator cluster;
determining in the accelerator list information indicating that the accelerators that have the same application computing logic as that of the target accelerator and are idle are candidate shunting accelerators; and
selecting the candidate shunting accelerator that satisfies the longest idle time and/or belongs to the first accelerators as the accelerator to be shunted.

In some embodiments, the target accelerator being in the computing overload state includes:
the target accelerator recording a full occupation timestamp when the local memory is fully occupied for the first time, and querying a local memory occupation state every query cycle; and
determining the local memory to be in the computing overload state in the case that the local memory is still fully occupied for a continuous preset cycle.

Since the embodiment of the apparatus section correspond to the embodiment of the method section each other, the embodiment of the apparatus section is described in the embodiment of the method section, and is not repeated here.

An embodiment in a tenth aspect of the present application is described as follows.

The present application further provides a distributed computing apparatus. The distributed computing method is applied to accelerators in a distributed accelerator cluster and includes:
an execution unit, configured to receive and execute computing tasks divided and assigned by a controller of the distributed cluster according to a service task; and
a shunting unit, configured to shunt the computing tasks to a direct-connected accelerator or to an indirect-connected accelerator via the controller while being in a computing overload state,
wherein the target accelerator is an accelerator that is in an idle state and has an application computing logic matching the type of the corresponding computing tasks; the distributed accelerator cluster includes a pre-established accelerator direct-connection pair, wherein the accelerator direct-connection pair includes two accelerators that are directly connected to each other, and at least one of the two accelerators is a first accelerator that supports a computer express link protocol and has an extended memory, and/or the two accelerators have the same application computing logic.

Since the embodiment of the apparatus section correspond to the embodiment of the method section each other, the embodiment of the apparatus section is described in the embodiment of the method section, and is not repeated here.

An embodiment in a eleven aspect of the present application is described as follows.

FIG. 6 is a schematic structural diagram of a distributed computing device provided by an embodiment of the present application.

As shown in FIG. 6, the distributed computing device provided by the embodiment of the present application includes:
a storage device 510, configured to store computer-readable instructions 511;
a processor 520, configured to execute the computer-readable instructions 511, the computer-readable instructions 501, when being executed by the processor 520, implementing the steps in the distributed computing method according to any one of the foregoing embodiments.

The processor 520 may include one or more processing cores, such as a 3-core processor and an 8-core processor. The processor 520 may be implemented by at least one hardware of a digital signal processing (DSP), a field-programmable gate array (FPGA), and a programmable logic array (PLA). The processor 520 may also include a main processor and a coprocessor. The main processor is a processor configured to process the data in an awake state, and is also called a central processing unit (CPU). The coprocessor is a low-power-consumption processor configured to process the data in a standby state. In some embodiments, the processor 520 may be integrated with a graphics processing unit (GPU), which is configured to render and draw the content that needs to be displayed by a display screen. In some embodiments, the processor 520 may also include an artificial intelligence (AI) processor configured to process compute operations related to machine learning.

The storage device 510 may include one or more non-volatile computer-readable storage mediums, which may be non-transitory. The storage device 510 may also include a high-speed random access memory, as well as a non-volatile memory, such as one or more disk storage devices and flash storage devices. In this embodiment, the storage device 510 is at least configured to store the following computer-readable instructions 511 therein, wherein the computer-readable instructions 511 are loaded and executed by the processor 520 to implement related steps in the distributed computing method disclosed in any of the foregoing embodiments. In addition, resources stored in the storage device 510 may also include an operating system 512 and data 513, and a storage method may be temporary storage or permanent storage. The operating system 512 may be Windows. The data 513 may include, but is not limited to, data involved in the foregoing methods.

In some embodiments, the distributed computing device may also include a display screen 530, a power source 540, a communication interface 550, an input/output interface 560, a sensor 570 and a communication bus 580.

It may be understood by those skilled in the art that the structure shown in FIG. 6 does not constitute any limitation to the distributed computing device, and may include more or less components than those illustrated.

The distributed computing device provided by this embodiment of the present application includes a memory and a processor, wherein the processor might implement the distributed computing method described above while executing the programs stored in the memory, achieving the effects as described above.

An embodiment in a thirteenth aspect of the present application is described as follows.

For example, the apparatus and device embodiments described above are merely schematic. For example, the partitioning of the modules might be a logical functional partitioning. There may be other partitioning modes during actual implementation. For example, multiple modules or components might be combined or integrated into another system, or some features might be ignored or not executed. In addition, mutual coupling or direct coupling or communication connection that is shown or discussed might be indirect coupling or communication connection through some interfaces, apparatuses or units, and might be in electrical, mechanical or other forms. The modules described as separate components may or may not be physically separated, and the components for unit display may or may not be physical units, that is, may be located in one place or distributed on a plurality of network modules. Part or all of the modules might be selected according to actual needs to achieve the object of the solution of this embodiment.

In addition, all functional modules in the embodiments of the present disclosure might be integrated into one processing module. Or, each module exists physically independently. Or, two or more modules might be integrated into one unit. The above integrated modules might be implemented in the form of hardware or software function modules.

The integrated modules, if implemented in the form of a software functional unit and sold or used as a separate product, may be stored in a non-volatile computer-readable storage medium. Based on this understanding, the technical solutions of the present application in essence (or parts contributed to the prior art) or all or part of the technical solutions may be embodied in the form of a software product. This computer software product is stored in a storage medium to perform all or part of the steps of the methods in respective embodiments of the present application.

Therefore, referring to FIG. 7, an embodiment of the present application further provides a non-volatile computer-readable storage medium, having computer-readable instructions stored therein, wherein the computer-readable instructions, when being executed by a processor, implement the steps in any of the above distributed computing methods.

The non-volatile computer-readable storage medium may include: a U disk, a portable hard disk, a read-only memory (ROM), a random access memory (RAM), a magnetic disk or an optical disc or other media that might store program codes therein.

The computer-readable instructions contained in the non-volatile computer-readable storage medium provided in this embodiment, when being executed by a processor, might implement the steps in any of the above distributed computing methods, achieving the effects as described above.

The distributed computing method, apparatus, device and system, and the non-volatile computer-readable storage medium provided by the present application are described in detail above. The respective embodiments of the present description are described in a progressive manner, the focus of each embodiment illustrates the differences from other embodiments, and the same similar parts among the embodiments may refer to one another. Since the apparatus and device and the non-volatile computer-readable storage medium disclosed in the embodiments correspond to the method and system disclosed in the embodiments, the description is relatively simple, and the relevant parts may refer to the description of the method and system sections. It should be pointed out that those of ordinary skill in the art may also make several improvements and modifications without departing from the principles of the present application, which should be considered as the protection scope of the present application.

It should be also noted that, as used in the present description, relation terms such as “first” and “second” are used merely to distinguish a subject or an operation from another subject or another operation, and not to require or imply any substantial relation or sequence between these subjects or operations. Moreover, terms “include”, “contain” or any variation thereof are intended to cover a nonexclusive containing, such that a process, a method, an item or a device containing a series of elements not only includes these elements, but also includes other elements that are not set forth in some embodiments, or also includes an inherent element of such a process, method, item or device. Without further limitation, an element defined by a phrase “include a . . . ” does not mean that other elements are excluded from the process, method, item or device including the same element.

1. A distributed computing method, applied to a controller of a distributed accelerator cluster, the distributed computing method comprising:
acquiring information of accelerators in the distributed accelerator cluster;
establishing an accelerator direct-connection pair according to the information of the accelerators; and
in response to receiving a service task, dividing the service task into computing tasks and distributing the computing tasks to a target accelerator which is idle and has an application computing logic matching a type of the computing tasks, whereby the target accelerator executes the computing tasks and shunts the computing tasks to a direct-connected accelerator or to an indirect-connected accelerator via the controller when the target accelerator is in a computing overload state,
wherein the accelerator direct-connection pair comprises two accelerators that are directly connected to each other, and
wherein at least one of: the two accelerators have the same application computing logic, or at least one of the two accelerators is a first accelerator that supports a computer express link protocol and has an extended memory.

2. The distributed computing method according to claim 1, wherein the target accelerator shunting the computing tasks to the direct-connected accelerator when the target accelerator is in the computing overload state comprises:
at least one of the target accelerator occupying the extended memory of the direct-connected accelerator or shunting the computing tasks to the direct-connected accelerator for execution when the target accelerator is in the computing overload state; and
the target accelerator shunting the computing tasks to the indirect-connected accelerator via the controller when the target accelerator is in the computing overload state comprises:
at least one of the target accelerator occupying an extended memory of the indirect-connected accelerator or shunting the computing tasks to the indirect-connected accelerator for execution via the controller when the target accelerator is in the computing overload state.

3. The distributed computing method according to claim 1, wherein the establishing the accelerator direct-connection pair according to the information of the accelerators comprises:
dividing the two accelerators in the distributed accelerator cluster and establishing the accelerator direct-connection pair, by taking the accelerator direct-connection pair assembled by two first accelerators having the same application computing logic as a first priority, the accelerator direct-connection pair assembled by one first accelerator and one second accelerator that does not support the computer express link protocol and has the same application computing logic as that of the first accelerator as a second priority, the accelerator direct-connection pair assembled by two second accelerators having the same application computing logic as a third priority, the accelerator direct-connection pair assembled by two first accelerators having different application computing logics as a fourth priority, and the accelerator direct-connection pair assembled by one first accelerator and one second accelerator having different application computing logics as a fifth priority.

4. The distributed computing method according to claim 1, wherein the dividing the service task into computing tasks and distributing the computing tasks to the target accelerator having the application computing logic matching the type of the corresponding computing tasks and not being occupied comprises:
selecting the target accelerator according to at least one of a direct-connection relationship and extended memory occupation, dividing the service task into computing tasks and distributing the computing tasks to the target accelerator.

5. The distributed computing method according to claim 1, wherein the dividing the service task into computing tasks and distributing the computing tasks to the target accelerator having the application computing logic matching the type of the corresponding computing tasks and not being occupied comprises:
dividing the service task into computing tasks, and assigning the computing tasks to the target accelerator in a following order of distribution priorities for the computing tasks:
a first assignment priority for the computing tasks is to assign the computing tasks to the two accelerators in the accelerator direct-connection pair, wherein the accelerator direct-connection pair comprises two idle first accelerators, the application computing logics of the two first accelerators match the types of the computing tasks, and extended memories of the two first accelerators are not occupied;
a second assignment priority for the computing tasks is to assign the computing tasks to the two accelerators in the accelerator direct-connection pair, wherein the accelerator direct-connection pair comprises two idle first accelerators, the application computing logics of the two first accelerators match the types of the computing tasks, and the extended memory of one of the first accelerators is occupied;
a third assignment priority for the computing tasks is to assign the computing tasks to the two accelerators in the accelerator direct-connection pair, wherein the accelerator direct-connection pair comprises one idle first accelerator and one idle second accelerator that does not support the computer express link protocol, the application computing logic of the first accelerator and the application computing logic of the second accelerator match the types of the computing tasks, and the extended memory of the first accelerator is not occupied;
a fourth assignment priority for the computing tasks is to assign the computing tasks to the two accelerators in the accelerator direct-connection pair, wherein the accelerator direct-connection pair comprises two idle first accelerators, the application computing logics of the two first accelerators match the types of the computing tasks, and the extended memories of the two first accelerators are occupied;
a fifth assignment priority for the computing tasks is to assign the computing tasks to the two accelerators in the accelerator direct-connection pair, wherein the accelerator direct-connection pair comprises two idle second accelerators, and the application computing logics of the two second accelerators match the types of the computing tasks;
a sixth assignment priority for the computing tasks is to assign the computing tasks to the target accelerator in the accelerator direct-connection pair, and only one of the two first accelerators in the accelerator direct-connection pair satisfies a condition of the target accelerator and an extended memory of the first accelerator is not occupied;
a seventh assignment priority for the computing tasks is to assign the computing tasks to the target accelerator in the accelerator direct-connection pair, wherein the accelerator direct-connection pair comprises one first accelerator and one second accelerator, and only the first accelerator satisfies the condition of the target accelerator and the extended memory of the first accelerator is not occupied;
an eighth assignment priority for the computing tasks is to assign the computing tasks to one individual first accelerator that satisfies the condition of the target accelerator and whose extended memory is not occupied;
a ninth assignment priority for the computing tasks is to assign the computing tasks to the target accelerator in the accelerator direct-connection pair, wherein the accelerator direct-connection pair comprises one first accelerator and one second accelerator, only the second accelerator satisfies the condition of the target accelerator and the extended memory of the first accelerator is not occupied;
a tenth assignment priority for the computing tasks is to assign the computing tasks to one individual first accelerator that satisfies the condition of the target accelerator and whose extended memory is occupied;
an eleventh assignment priority for the computing tasks is to assign the computing tasks to the target accelerator in the accelerator direct-connection pair, wherein the accelerator direct-connection pair comprises one first accelerator and one second accelerator, and only the second accelerator satisfies the condition of the target accelerator and the extended memory of the first accelerator is occupied; and
a twelfth assignment priority for the computing tasks is to assign the computing tasks to one individual second accelerator that satisfies the condition of the target accelerator.

6. The distributed computing method according to claim 1, wherein the target accelerator executing the computing tasks and shunting the computing tasks to the direct-connected accelerator or to the indirect-connected accelerator via the controller when the target accelerator is in the computing overload state comprises:
the target accelerator shunting the computing tasks to the direct-connected accelerator for the target accelerator in a case that the target accelerator is in the computing overload state and the direct-connected accelerator for the target accelerator satisfies a condition that it is in an idle state and has the same application computing logic as that of the target accelerator; and
assigning the indirect-connected accelerator to the target accelerator as an accelerator to be shunted, whereby the target accelerator shunts the computing tasks to the accelerator to be shunted, in the case that the target accelerator is in the computing overload state and no direct-connected accelerator is provided for the target accelerator or the direct-connection accelerator for the target accelerator is in a non-idle state or the direct-connected accelerator for the target accelerator has different application computing logic from that of the target accelerator.

7. The distributed computing method according to claim 6, wherein the target accelerator shunting the computing tasks to the direct-connected accelerator for the target accelerator in the case that the target accelerator is in the computing overload state and the direct-connected accelerator for the target accelerator satisfies a condition that it is in an idle state and has the same application computing logic as that of the target accelerator comprises:
in response to receiving a shunting request sent by the target accelerator in the computing overload state, querying to find an accelerator state information table corresponding to the target accelerator according to an identifier of the target accelerator: setting usage state information in the accelerator state information table corresponding to the direct-connected accelerator for the target accelerator to be non-idle, a start time to the time of the current timestamp, and an end time to 0 in the case that the information of the direct-connected accelerator for the target accelerator is found from the accelerator state information table corresponding to the target accelerator, and the accelerator state information table corresponding to the direct-connected accelerator for the target accelerator is found according to the identifier of the direct-connected accelerator for the target accelerator to determine that the direct-connected accelerator for the target accelerator is in the idle state and has the same application computing logic as that of the target accelerator;
feeding information indicating that the direct-connected accelerator for the target accelerator satisfies a compute shunting condition back to the target accelerator, whereby the target accelerator shunts the computing tasks to the direct-connected accelerator for the target accelerator;
in response to receiving information indicating that the computing tasks sent by the target accelerator have been completed, querying to find the accelerator state information table corresponding to the target accelerator according to the identifier of the target accelerator, and setting the usage state information in the accelerator state information table corresponding to the target accelerator to be idle, the start time to 0, and the end time to the time of the current timestamp; and
in response to receiving information indicating that the computing tasks sent by the direct-connected accelerator for the target accelerator have been completed, querying to find the accelerator state information table corresponding to the direct-connected accelerator for the target accelerator according to the identifier of the direct-connected accelerator for the target accelerator; setting the usage state information in the accelerator state information table corresponding to the direct-connected accelerator for the target accelerator to be idle, the start time to 0 and the end time to a time of the current timestamp.

8. The distributed computing method according to claim 7, wherein the feeding the information indicating that the direct-connected accelerator for the target accelerator satisfies the compute shunting condition back to the target accelerator, whereby the target accelerator shunts the computing tasks to the direct-connected accelerator for the target accelerator comprises:
feeding information indicating that the direct-connected accelerator for the target accelerator satisfies the compute shunting condition and that the extended memory is not occupied back to the target accelerator, whereby at least one of the target accelerator shunts the computing tasks to the direct-connected accelerator for the target accelerator for execution or share the extended memory of the direct-connected accelerator for the target accelerator, in the case that the direct-connected accelerator for the target accelerator is determined to be the first accelerator and the extended memory is not occupied according to the accelerator state information table corresponding to the direct-connected accelerator for the target accelerator; and
feeding information indicating that the direct-connected accelerator for the target accelerator satisfies the compute shunting condition back to the target accelerator, whereby the target accelerator shunts the computing tasks to the direct-connected accelerator for the target accelerator for execution, in the case that the direct-connected accelerator for the target accelerator is determined to be the second accelerator that does not support the computer express link protocol or the direct-connected accelerator for the target accelerator is the first accelerator, but the extended memory is occupied, according to the accelerator state information table corresponding to the direct-connected accelerator for the target accelerator.

9. The distributed computing method according to claim 6, wherein in that the assigning the indirect-connected accelerator to the target accelerator as an accelerator to be shunted, whereby the target accelerator shunts the computing tasks to the accelerator to be shunted, in the case that the target accelerator is in the computing overload state and no direct-connected accelerator is provided for the target accelerator or the direct-connection accelerator for the target accelerator is in a non-idle state or the direct-connected accelerator for the target accelerator has different application computing logic from that of the target accelerator, comprises:
in response to receiving a shunting request sent by the target accelerator in the computing overload state, querying to find an accelerator state information table corresponding to the target accelerator according to an identifier of the target accelerator: acquiring information of idle accelerators in the distributed accelerator cluster, selecting the accelerator that has an application computing logic matching the type of the corresponding computing tasks from the idle accelerators as the accelerator to be shunted, and setting usage state information in the accelerator state information table corresponding to the accelerator to be shunted to be non-idle, a start time to the time of the current timestamp, and an end time to 0, in a case that the information of the direct-connected accelerator for the target accelerator is not found in the accelerator state information table corresponding to the target accelerator, or that the information of the direct-connected accelerator for the target accelerator is found in the accelerator state information table corresponding to the target accelerator and the accelerator state information table corresponding to the direct-connected accelerator for the target accelerator is found according to the identifier of the direct-connected accelerator for the target accelerator to determine that the direct-connected accelerator for the target accelerator is in a non-idle state and has different application computing logic from that of the target accelerator;
feeding information indicating that the accelerator to be shunted satisfies a compute shunting condition back to the target accelerator, whereby the target accelerator shunts the computing tasks to the accelerator to be shunted;
in response to receiving information indicating that the computing tasks sent by the target accelerator have been completed, querying to find the accelerator state information table corresponding to the target accelerator according to the identifier of the target accelerator, and setting the usage state information in the accelerator state information table corresponding to the target accelerator to be idle, the start time to 0, and the end time to the time of the current timestamp; and
in response to receiving information indicating that the computing tasks sent by the accelerator to be shunted have been completed, querying to find the accelerator state information table corresponding to the accelerator to be shunted according to the identifier of the accelerator to be shunted, and setting the usage state information in the accelerator state information table corresponding to the accelerator to be shunted to be idle, the start time to 0, and the end time to the time of the current timestamp.

10. The distributed computing method according to claim 9, wherein the feeding the information indicating that the accelerator to be shunted satisfies the compute shunting condition back to the target accelerator, whereby the target accelerator shunts the computing tasks to the accelerator to be shunted comprises:
feeding information indicating that the accelerator to be shunted satisfies the compute shunting condition and that the extended memory is not occupied back to the target accelerator, whereby at least one of the target accelerator shunts the computing tasks to the accelerator to be shunted for execution or share the extended memory of the accelerator to be shunted, in the case that the accelerator to be shunted is determined to be the first accelerator and the extended memory is not occupied according to the accelerator state information table corresponding to the accelerator to be shunted; and
feeding information indicating that the accelerator to be shunted satisfies the compute shunting condition back to the target accelerator, whereby the target accelerator shunts the computing tasks to the accelerator to be shunted for execution, in the case that the accelerator to be shunted is determined to be the second accelerator that does not support the computer express link protocol or the accelerator to be shunted is determined to be the first accelerator, but the extended memory is occupied, according to the accelerator state information table corresponding to the accelerator to be shunted.

11. The distributed computing method according to claim 1, wherein the two accelerators in the accelerator direct-connection pair share local application computing logic types, usage state information, whether to support the computer express link protocol and whether to occupy the extended memories through a direct-connected channel, and record information of the direct-connected accelerator to a direct-connected accelerator state information table.

12. (canceled)

13. The distributed computing method according to claim 1, wherein the establishing the accelerator direct-connection pair comprises:
establishing the accelerator direct-connection pair by applying an inter-kernel communication protocol; and
the target accelerator shunting the computing tasks to the direct-connected accelerator comprises:
the target accelerator shunting the computing tasks to the direct-connected accelerator for the target accelerator on the basis of an inter-kernel high-speed transmission link.

14. The distributed computing method according to claim 1, wherein the target accelerator shunting the computing tasks to the indirect-connected accelerator via the controller comprises:
receiving a shunting request sent by the target accelerator;
determining an accelerator to be shunted on the basis of the shunting request; and
sending information of the accelerator to be shunted to the target accelerator, whereby the target accelerator shunts the computing tasks to the accelerator to be shunted via a routing subnetwork.

15. The distributed computing method according to claim 14, wherein the target accelerator shunting the computing tasks to the accelerator to be shunted via the routing subnetwork comprises:
the target accelerator shunting the computing tasks to the accelerator to be shunted via the routing subnetwork on the basis of a remote direct memory access protocol.

16. The distributed computing method according to claim 14, wherein the determining the accelerator to be shunted according to the shunting request comprises:
acquiring an accelerator list of the distributed accelerator cluster;
determining in the accelerator list information indicating that the accelerators that have the same application computing logics as that of the target accelerator and are idle are candidate shunting accelerators; and
at least one of selecting the candidate shunting accelerator that satisfies the longest idle time or belongs to the first accelerators as the accelerator to be shunted.

17. The distributed computing method according to claim 1, wherein the target accelerator being in the computing overload state comprises:
the target accelerator recording a full occupation timestamp when local memory is fully occupied for the first time, and querying a local memory occupation state every query cycle; and
determining the local memory to be in the computing overload state in the case that the local memory is still fully occupied for a continuous preset cycle.

18. A distributed computing method applied to a target accelerator in a distributed accelerator cluster, the distributed computing method comprising:
receiving and executing computing tasks divided and assigned by a controller of the distributed cluster according to a service task;
shunting the computing tasks to a direct-connected accelerator or to an indirect-connected accelerator via the controller when the target accelerator is in a computing overload state,
wherein the target accelerator is an accelerator that is in an idle state and has an application computing logic matching the type of the computing tasks; the distributed accelerator cluster comprises a pre-established accelerator direct-connection pair, wherein the accelerator direct-connection pair comprises two accelerators that are directly connected to each other, and at least one of: the two accelerators have the same application computing logic, or at least one of the two accelerators is a first accelerator that supports a computer express link protocol and has an extended memory.

19.-21. (canceled)

22. A distributed computing system comprises a distributed accelerator cluster and a controller,
wherein the controller is configured to acquire information of accelerators in the distributed accelerator cluster; establish an accelerator direct-connection pair according to the information of the accelerators; and in response to receiving a service task, divide the service task into computing tasks and distribute the computing tasks to an idle target accelerator having an application computing logic matching the type of the corresponding computing tasks, whereby the target accelerator executes the computing tasks and shunts the computing tasks to a direct-connected accelerator or to an indirect-connected accelerator via the controller when the target accelerator is in a computing overload state,
wherein the accelerator direct-connection pair comprises two accelerators that are directly connected to each other, and at least one of the two accelerators is a first accelerator that supports a computer express link protocol and has an extended memory, and/or the two accelerators have the same application computing logic.

23. A distributed computing device comprises:
a storage device, configured to store computer-readable instructions therein; and
a processor, configured to execute the computer-readable instructions, the computer-readable instructions, when executed by the processor, implementing the distributed computing method according to claim 1.

24. A non-transitory computer-readable storage medium, having computer-readable instructions stored therein, wherein the computer-readable instructions, when executed by a processor, implement the distributed computing method according to claim 1.
